(19) United States
(12) Patent Application Publication
(10) Pub. No.: US 2018/0285588 A1
(43) Pub. Date: Oct. 4, 2018

(54) SYSTEMS AND METHODS FOR RESOURCE MANAGEMENT

(71) Applicant: JPMorgan Chase Bank, N.A., New York, NY (US)

(72) Inventors: Trupti A. Gaikwad, Jersey City, NJ (US); Jacqueline Spotts, National Park, NJ (US); David L. Luce, JR., Lewis Center, OH (US); Geoffrey A. Novak, Canton, MI (US)

(21) Appl. No.: 14/507,301

(22) Filed: Oct. 6, 2014

Related U.S. Application Data
(63) Continuation-in-part of application No. 13/230,334, filed on Sep. 12, 2011, now abandoned.

(51) Int. Cl. G06F 21/62; G06F 17/30

(52) U.S. Cl. CPC G06F 21/6227; G06F 17/30554; G06F 17/30424

(57) ABSTRACT

Systems and methods for resource management are disclosed. According to one embodiment, a computer implemented method for controlling access to and editing of an organizational directory may include (1) receiving an identification of an individual to whom to grant at least one permission and an identification of a role out of a plurality of roles for an organization for the individual, each role of the plurality of roles having associated therewith at least one permission; (2) at least one computer processor assigning the role to the individual; (3) receiving a request for information from the individual regarding a database entry; (4) the at least one computer processor verifying that the at least one permission authorizes access to the requested information; and (5) the at least one computer processor providing access to the requested information.

### CROSS REFERENCE TO RELATED APPLICATIONS

This patent application is a Continuation-in-Part of U.S. patent application Ser. No. 13/230,334, filed on Sep. 12, 2011, entitled “System and Method for Human Resource Management.” The contents of this priority application are hereby incorporated by reference in its entirety.

### FIELD OF THE INVENTION

The invention relates generally to systems and methods for resource management.

### BACKGROUND OF THE INVENTION

Entities, for example, such as business entities, organizations, and firms, have employees. In particular, larger entities, such as larger corporations, can have hundreds or thousands of employees. These employees are a vital resource of the entity. In many case, the employees are referred to as personnel.

In order to manage its employees and to function efficiently, entities typically have an organizational structure which includes various subdivisions, such as different departments and divisions. Each subdivision can be further subdivided. Each subdivision has a manager or supervisor who is in charge. It is in the business interests of the entity to have a succession plan to fill that manager or supervisor's position. However, effective tools are lacking to manage succession plans and to enable an entities management structure to make informed decisions on succession. Succession planning is typically performed using a manual process involving bulletin type boards and papers or images on that board. A system using a magnetic board and magnets is employed in some cases. This process is manually intensive and lacks automation or any type of electronic interface to record or preserve a status or results.

These and other deficiencies exist.

### SUMMARY OF THE INVENTION

Systems and methods for resource management are disclosed. According to one embodiment, a computer implemented method for controlling access to and editing of an organizational directory may include (1) receiving an identification of an individual to whom to grant at least one permission and an identification of a role out of a plurality of roles for an organization for the individual, each role of the plurality of roles having associated therewith at least one permission; (2) at least one computer processor assigning the role to the individual; (3) receiving a request for information from the individual regarding a database entry; (4) the at least one computer processor verifying that the at least one permission authorizes access to the requested information; and (5) the at least one computer processor providing access to the requested information.

In one embodiment, the request is to at least one of access, edit, search for, and delete the database entry.

In one embodiment, the database entry is an individual profile for a member of the organization, an individual profile for a non-member of the organization, an identification of a successor for a member of the organization, etc.

In one embodiment, the permission comprises a hierarchy of permissions, and the hierarchy of permissions may be based on a level of role.

Computer implemented systems and methods for organizational planning are disclosed. In one embodiment, the method may include (1) receiving an identification of a first individual in a first position; (2) at least one computer processor identifying a plurality of success characteristics for the first individual from a first profile for the first individual; (3) the at least one computer processor identifying, from at least one database comprising a plurality of profiles, at least one second individual having a second profile comprising a predetermined amount of the success characteristics; and (4) the at least one computer processor performing predictive modeling to determine a likelihood of success for the second individual in the first position.

In one embodiment, the method may further include receiving an identification of at least one exclusion characteristic, wherein the at least one second individual does not match a predetermined amount of the exclusion characteristics.

In one embodiment, the step of performing predictive modeling to determine a likelihood of success for the second individual in the first position may include the at least one computer processor applying the second profile to historical data to determine the likelihood of success for the second individual.

In one embodiment, the success characteristics may include an education level, a skill, a personality trait, a training level, and a review.

Systems and methods for organizational planning are disclosed. According to one embodiment, a method may include (1) receiving an identification of an analysis goal; (2) at least one computer processor identifying at least one individual that meets the analysis goal; (3) the at least one computer processor identifying an action to take for the identified individual; and (4) the at least one computer processor taking the identified action for the identified individual.

In one embodiment, the method may also include the at least one computer processor identifying at least one successor for the identified individual.

In one embodiment, the analysis objective is to identify an individual that is likely to leave an organization.

Another exemplary embodiment may be a computer based system configured to execute the computer based method described above. The computer based system may have computer hardware, including one or more computer processors, computer memory, computer storage, and one or more displays. The computer hardware may be one or more servers and the one or more servers may be communicatively coupled to a computer network, such as the Internet and/or a local area network. The computer hardware may have software installed thereon. The software may be configured into modules to execute the method. The software may be read by the computer from a computer readable medium. The software may be executed by the one or more computer processors.

Advantages of this invention in addition to those described above are apparent from the following detailed description of the exemplary embodiments.

### BRIEF DESCRIPTION OF THE DRAWINGS

FIG. 1 is a flow chart of a method for succession planning in accordance with an exemplary embodiment.

FIG. 2 is a system for succession planning in accordance with an exemplary embodiment.

FIG. 3 is a display screen of an organizational chart in accordance with an exemplary embodiment.

FIG. 4 is an information card in accordance with an exemplary embodiment.

FIG. 5 is a display of multiple information cards in accordance with an exemplary embodiment.

FIG. 6 is a successor for display in accordance with an exemplary embodiment.

FIG. 7 is a successors display in accordance with an exemplary embodiment.

FIG. 8 is a profile waiting area display in accordance with an exemplary embodiment.

FIG. 9 is a report display in accordance with an exemplary embodiment.

FIG. 10 is a display screen of an organizational chart in accordance with an exemplary embodiment.

FIG. 11 is an illustration of a home page according to an exemplary embodiment.

FIG. 12 is an illustration of a wall according to an exemplary embodiment.

FIG. 13 is an illustration of a profile according to an exemplary embodiment.

FIG. 14 is an illustration of a profile according to another exemplary embodiment.

FIG. 15 is a visual representation of an organization's hierarchy and relationships according to an exemplary embodiment.

FIGS. 16A and B are illustrations of visual succession planning according to an exemplary embodiment.

FIG. 17 depicts an example administrative interface according to an exemplary embodiment.

FIG. 18 depicts an example “Get Services” interface according to an exemplary embodiment.

FIG. 19 depicts an example “New Hire” interface according to an exemplary embodiment.

FIG. 20 depicts an example “Manage User” interface according to an exemplary embodiment.

FIG. 21 depicts an example “Locked Walls” interface according to an exemplary embodiment.

FIG. 22 depicts an example “Master Data” interface according to an exemplary embodiment.

FIG. 23 depicts an example “User Log” interface according to an exemplary embodiment.

FIG. 24 depicts an example “Manage Organizations” interface according to an exemplary embodiment.

FIG. 25 depicts an example “Bulk Upload” interface according to an exemplary embodiment.

FIG. 26 depicts an example of an hierarchy editing interface according to an exemplary embodiment.

FIG. 27 depicts an example interface for the bulk assigning of roles according to an exemplary embodiment.

FIGS. 28A and 28B are example “Manage User” interfaces according to an exemplary embodiment.

FIG. 29 depict an example search interface according to an exemplary embodiment.

FIG. 30 depicts a method for role assignment according to an exemplary embodiment.

FIG. 31 depicts a method for automatically identifying successor candidates according to an exemplary embodiment.

FIG. 32 depicts a method for analyzing individuals according to one embodiment.

These and other embodiments and advantages of exemplary embodiments will become apparent from the following detailed description, taken in conjunction with the accompanying drawings, illustrating by way of example the principles of the various exemplary embodiments.

### DETAILED DESCRIPTION OF THE PREFERRED EMBODIMENTS

It will be readily understood by those persons skilled in the art that the embodiments of the inventions described herein are capable of broad utility and application.

Accordingly, while the various embodiments are described herein in detail in relation to the exemplary embodiments, it is to be understood that this disclosure is illustrative and exemplary of embodiments and is made to provide an enabling disclosure. Accordingly, the disclosure is not intended to be construed to limit the embodiments or otherwise to exclude any other such embodiments, adaptations, variations, modifications and equivalent arrangements. While the various embodiments are described in the context of inspections of physical plants and property, the methods and systems described herein may be applied to other related items, such as other types of inspections and quality control environments in manufacturing and industry.

The following descriptions are provided of different configurations and features according to exemplary embodiments. These configurations and features may relate to performing collaborative succession planning and organizational structure managements. Such planning may be provided through electronic interaction with an application or computing devices over a computer network, such as the Internet. While certain nomenclature and types of applications/hardware are described, other names and application/hardware usage is possible and the nomenclature provided is done so by way of non-limiting examples only. Further while particular embodiments are described, these particular embodiments are meant to be exemplary and non-limiting and it further should be appreciated that the features and functions of each embodiment may be combined in any combination as is within the capability of one of ordinary skill in the art. For example, while the following methods and systems may be illustrated using certain examples relating to planning for a corporate entity, such as a financial institution, these examples are meant to be exemplary and non-limiting.

Embodiments include an application to facilitate collaborative succession planning within an entity. The entity may be a corporate entity, such as, for example, a business, an organization, or a firm. These terms may be used interchangeably throughout the present disclosure and are meant to be exemplary and non-limiting in nature. For example, the entity may be a financial institution or sports team.

The application may be referred to as a “talent wall” application. The application may be designed to be visual based and to utilize interactive electronic screens or displays. For example, smart or touch boards may be used. However, the application may be designed to be extensible and support deployment on a variety computing devices, including portable computing devices, and be connected over a computer based network. For example, the application may be executed on computers or tablet computing devices. The electronic screens or displays may be assembled into a central location which may be referred to as a “talent room.” The application may have a number of features including: display of organization charts, comparison of talent using profiles based on background and experience, flexibility to download information to a computer or tablet device, drill down views of charts and succession plans at any organization level, and real-time updating and reporting. The organizational chart may be a hierarchical chart and may represent or be referred to a “talent wall.” Information and data on persons in the entity may be obtained from existing sources in the entity such as a phonebook or personnel directory. Other sources and combinations of sources may be used. The application may synthesize these multiple sources. Each individual in the entity may have an information card. This information card may structured like and akin to a typical “baseball card.” Each card may be viewed by selecting an individual in the talent wall. The card may provide information or statistics (or “stats”) related to that individual. Individuals can be moved between organizations and hypothetical organization charts can be created. By moving an individual, succession may be planned for one or more positions in the entity. A key feature may be the ability to perform a “drag and drop” of individuals between organizations or positions. Importantly, succession information may be clearly displayed. For example, from an individual's card, the successors to the individual can be viewed as well as the individuals to which the selected individual is a successor for. Criteria for each position in the organization may be entered and used to find and match possible successors for that position. A matrix reporting capability may be used whereby a person that reports into one part of the entity may report into another and the application may reflect that reporting relationship. A search capability may be used to located individuals and various reports can be generated from the application. Individuals accessing the application may have access rights based on their subscriber ID (‘SID”) as to what functions they are capable of performing and what levels of the organization they can view. Hypothetical charts and successions may planned and performed, with any individual moves being reversible. These and other features are possible.

Exemplary embodiments therefore provide a number of advantages, which include, but are not limited to, drag and drop functionality, portability and extensibility to a variety of platforms including, but not limited to, desktop or server computers, laptop computers, tablet computing devices, smart phones, touch boards, and smart boards, linking to existing entity personnel data information, such as in a directory or phonebook, the ability to efficiently move up, down, and across organization levels, matrix reporting capability, and the combination of tools used to implement the exemplary embodiments.

The attached Figures provide details regarding the various embodiments.

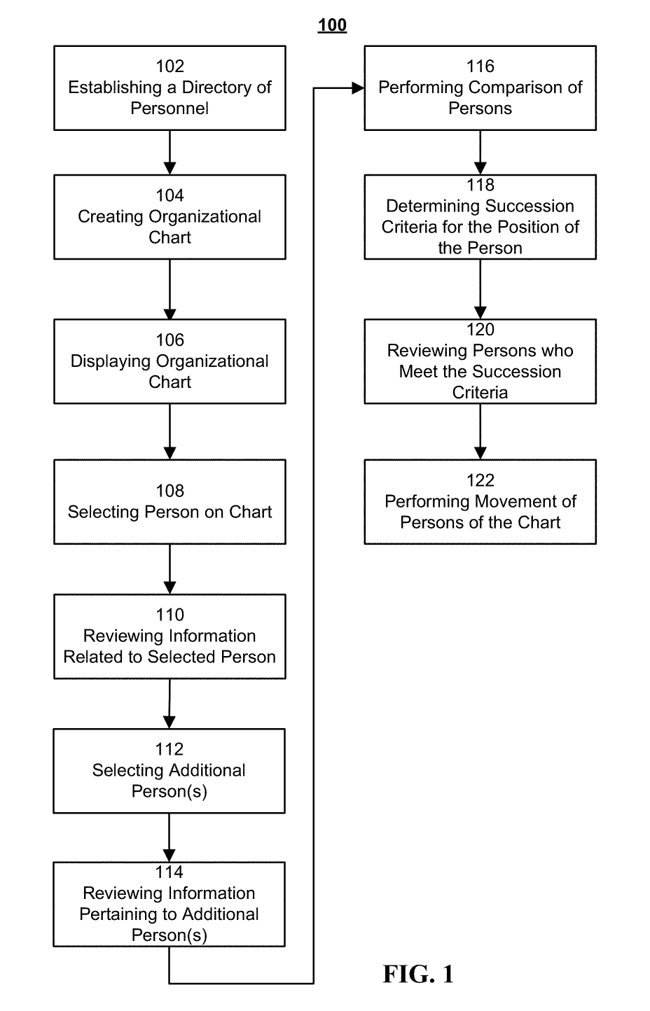

FIG. 1 depicts a flow chart of a method of performing collaborative succession using a computer system according to exemplary embodiments. Exemplary method 100 is provided by way of example, as there are a variety of ways to carry out the methods disclosed herein. The method 100 as shown in FIG. 1 may be executed or otherwise performed by one or a combination of various systems, such as a computer implemented system. Each block shown in FIG. 1 represents one or more processes, methods, and/or subroutines carried out in the exemplary method 100. Each block may have an associated processing machine or the blocks depicted may be carried out through one processor machine.

As a precursor to the method 100, an application may be executed on a computing device. The application may be an application for collaborative succession planning. For example, the application may be the talent wall application. The application may be accessed through executing a software module on the computing device. The computing device may require a log-in as an access measure. The application may require a log-in. The log-in may serve to identify the user. Each user may be assigned certain rights that determines what actions the user can take and what information the user can access. For example, a user may limited to certain parts of the organization of the entity that correspond to their position in the entity. In some embodiments, a user may be able to access data pertaining to the entire organization, that is all the personnel, but may be limited as to the action that the user can perform and limited as to the personnel on whom the action can be performed. For example, a user may be able to see all of the personnel in an organization and create an organization chart, however the user may only be able to select certain individuals who they supervise to view information or to perform succession planning with respect to.

At block 102, a directory of personnel associated with an entity is established. The directory may be based upon or sourced from an existing directory in the entity. For example, a phone listing or email listing may be used as the information source. The directory may be dynamically established upon accessing the application as described above. In the manner, the directory may contain any updated information from the last access.

At block 104, an organizational chart is created. The organizational chart may be created from the directory. The organizational chart may be hierarchical in structure. The organizational chart may reflect the administrative or managerial structure of the entity. According to some embodiments, there may be multiple organizational charts for an entity. These organizational charts may be arranged and accessed through a series of tabs or icons on the display.

At block 106, the organizational chart is displayed. The organizational chart may be electronically displayed. For example, the organizational chart may be displayed on one or more computer displays. Large screen type displays may be used. The displays may be touch screens or smart boards. The organizational chart may have a legend to provide a visual reference to the status of persons on the organizational chart. The legend may be a color coded legend to provide visual contrast between certain persons on the chart.

The organizational chart displayed may be a chart of successors for a particular person. Stated differently, a person may be identified and an organizational chart may be created that identifies the potential successors for that person. The chart may show the successors in their current positions with the people who are successor for them. The particular person for which the organizational chart is based may be identified in a separate box upon the chart. This particular person may be the person who logged into or accessed the application. For example, a person may log into the application and may be presented with a chart based on their succession line. In other embodiments, the particular person may be selected either through a search or by inputting that person's name.

At block 108, a person on the organizational chart is selected. The person may be selected using through an interface to the organizational chart. The person may be selected using an input device to a computer system. For example, the person may be selected using a mouse, a pointing device, or a touch screen. This person may be the first person selected.

At block 110, information relating to the selected person is reviewed. Once selected, information relating to the selected person may be displayed. This information may appear in a window or frame on the display. The window may be a pop-up type window such that the information is overlaid on the organizational chart. For example, the pop-up window may be in the foreground of the display and the organizational chart is in the background. The information may be displayed in a “baseball card” type layout. A variety of information relating to the person may be displayed. A part of the information, one or more successors to the person may be identified. For some persons, a successor may not be identified. Criteria relating to the persons positions may be listed. Criteria may be able to be chosen relating to succession to the person's position. For example, a person may be listed as having certain experience in particular areas and/or may have a certain skill set and/or the person may have a particular education level. Further, a list of criteria may be displayed from which choices can be made relating to criteria that a successor is desired to possess.

At block 112, an additional person or person(s) is selected. This person or person(s) may be selected from the organizational chart. In some embodiments, the person or persons may be selected from the baseball card of the first person selected in that they are identified successors to the first person. This may be the second and higher persons selected.

At block 114, information relating to the additional person(s) selected is reviewed. This information may be displayed in the same format as with the first person. The information may be displayed side-by-side with the first person's information. This side-by-side type display may facilitate comparison between each of the selected persons.

At block 116, a comparison between the selected persons is performed.

At block 118, succession criteria for the first person is determined. The succession criteria may be determined by a selection of criteria from a listing on the first person's baseball card. Once selected, a search for persons meeting the identified criteria may be performed.

At block 120, a review of the search results is performed.

At block 122, movement of one or more persons on the organizational chart is performed. A person or persons may be selected and moved to a different position on the organizational chart. Such moves can be performed in a hypothetical manner such that the moves may be reversed. Movement may be performed through a drag and drop type process using the display interface. People may be moved between organizational charts through selection and dragging onto a tab for another organizational chart. The person may dropped and they will be placed into a profile waiting area for the other organizational chart. If the person is not dropped, then the other organizational chart may open (be displayed) and the person may be placed into a position in the chart. A grayed out or vacant box may appear in the original organizational chart. This vacant box may be deleted if the position is no longer desired.

A person may be moved directly into a position that is already occupied. In this situation, the original person in the position may be displaced into the profile waiting area.

When a person is moved, and a position deleted, any personnel who were under that deleted position may be moved into the profile waiting area. These personnel may be moved up a level or into new positions. According to some embodiments, new positions or branches in the organizational chart may be created.

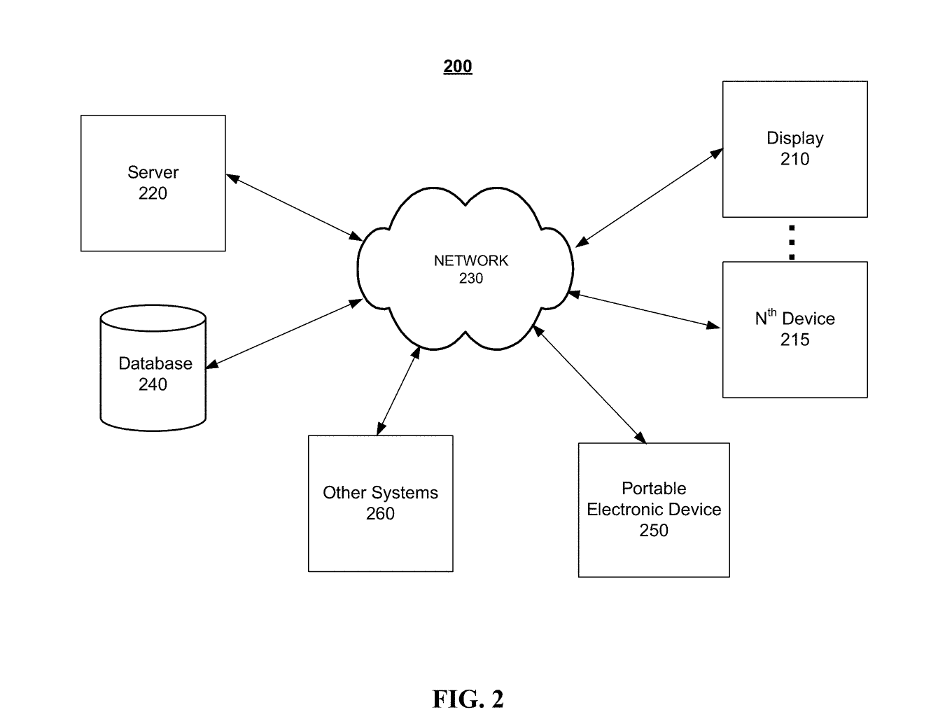

FIG. 2 is a system according to an exemplary embodiment. System 200 may provide various functionality and features associated with the program. While a single illustrative block, module or component is shown, these illustrative blocks, modules or components may be multiplied for various applications or different application environments. In addition, the modules or components may be further combined into a consolidated unit. The modules and/or components may be further duplicated, combined and/or separated across multiple systems at local and/or remote locations. For example, some of the modules or functionality associated with the modules may be supported by a separate application or platform. Other implementations and architectures may be realized. It should be appreciated that system 200 may be integrated into and run on a computer, which may include a programmed processing machine which has one or more processors. Such a processing machine may execute instructions stored in a memory to process the data. System 200 may be integrated into and run on one or more computer networks which may each have one of more computers associated therewith. Further, while a particular structure or type of component is shown, this structure is meant to be exemplary, as other structure or components may be able to be substituted to perform the functions described.

As noted above, the processing machine executes the instructions that are stored in the memory or memories or persistent data storage devices to process data. This processing of data may be in response to commands by a user or users of the processing machine, in response to previous processing, in response to a request by another processing machine and/or any other input, for example. As described herein, a module performing functionality may have a processor.

According to exemplary embodiments, the system 200 may be configured to carry out the methods and display the screens and interfaces as described herein. For example, the method 100 may be conducted by the system 200. The system 200 may support other methods and be communicatively coupled to other systems. FIG. 2 may have various connection arrows between its components. The connection arrows may indicate a direction of data exchange between the components. These directions are exemplary and non-limiting in nature.

The system 200 may have a display 210 associated therewith. A Nth display 215 may be further associated with the system 200. For example, the system 200 have display 210 and a second display 215. Additional displays may be used. The display 210 and Nth display 215 may be large displays. The displays 210 and 215 may be smart board or touch type displays. The displays 210 and 215 may be computer monitors. In some embodiments, the displays 210 and 215 may be large screen television type displays with multiple uses, such as display of television and computer signals. The displays may be cathode ray tube, plasma or liquid crystal type displays. Other types of displays may be used. The displays 210 and 215 may include one or more computer processors or processing machines. Each display may include software and/or modules to implement the methods described herein according to exemplary embodiments. Each display 210 and 215 may provide processing, display, storage, communications, and execution of commands in response to inputs from a user thereof and respond to requests from the software and/or modules. The displays 210 and 215 may be coincidentally located. For example, in a system 200 with multiple displays 210 and 215, the displays may be located in a single room, arranged on one or more walls or surfaces of the room to enable viewing of the multiple displays at the same time. In a system 200 with multiple displays 210 and 215, the displays may be linked to together such that the displays may be considered as one. For example, each display may be accessed by the system 200 and the information displayed may span across more than one display. In some embodiments, different displays may be capable of displaying different information or screens.

Each display 210 and 215 may have a display and an input device associated therewith. The input device may be a single device or a combination of devices. For example, the input devices may include a keyboard, both full-sized QWERTY and condensed, a numeric pad, an alpha-numeric pad, a track ball, a touch pad, a mouse, selection buttons, and/or a touch screen. Pointing devices associated with each display 210 and 215 may move between the displays 210 and 215 to provide a seamless interface and access to each display amongst the multiple displays. The displays 210 and 215 may include other devices such as a printer and a device for accepting deposits and/or dispensing currency and coins.

In some embodiments, the displays 210 and 215 may be a portable or hand-held computing or electronic device, or other type of computing device, that has the described functionality. For example, the displays 210 and 215 may be tablet computing devices. Additional devices may be coupled to the portable or hand-held computing device to perform various functions such as accepting deposits or dispensing currency.

The system 200 may include a server 220. The server 220 may be a processing machine with one or more computer processors associated therewith. The server 220 may perform operations associated with the establishment, configuration, and application of the programs accordingly to exemplary embodiments. For example, the server 220 may host the talent wall application. The server 220 may consist of one or more servers and/or general purpose computers, each having one or more computer processors associated therewith.

The server 220 may have one or more storage devices associated therewith. The storage may be local, remote, or a combination thereof with respect to the server 220. The storage may utilize a redundant array of disks (RAID), striped disks, hot spare disks, tape, disk, or other computer accessible storage. In one or more embodiments, the storage may be a storage area network (SAN), an Internet small computer systems interface (iSCSI) SAN, a Fiber Channel SAN, a common Internet File System (CIFS), network attached storage (NAS), or a network file system (NFS). The storage may have back-up capability built-in. The back-up capability of the storage may be used to archive image data for later use. The back-up capability may be used for recovery of data in the event of a failure of the storage.

The displays 210 and 215 and the server 220 may be communicatively coupled to a network 230. Accordingly, the displays 210 and 215 and the server 220 may be geographically dispersed. Conversely, two or more of displays 210 and 215 and the server 220 may be located in close proximity. Network 230 may be a computer based network, with one or more servers and/or computer processors. For example, network 230 may be the Internet or a network connected to the Internet. The network 230 may be a satellite or cellular based network. Information and data may be exchanged through the network 230 between the various components of the system 200. In alternative embodiments, the network 230 may be a local area network within the entity that may be connected to or interface with the Internet. It should be appreciated that the network 230 may be a combination of local area networks, wide area networks, and external networks, which may be connected to the Internet.

The system 200 may have a database 240. The database 240 may contain data and information used by the system 200. For example, the database 240 may store the directory information of personnel employed by the entity. Additional information maybe contained therein related to the operation and administration of the system 200. The database 240 may include any suitable data structure to maintain the information and allow access and retrieval of the information. For example, the database may keep the data in an organized fashion. The database 240 may be a database, such as an Oracle database, a Microsoft SQL Server database, a DB2 database, a MySQL database, a Sybase database, an object oriented database, a hierarchical database, a flat database, and/or another type of database as may be known in the art that may be used to store and organize rule data as described herein.

The database 240 may be stored in any suitable storage device. The storage device may include multiple data storage devices. The multiple data storage devices may be operatively associated with the database 240. The storage may be local, remote, or a combination thereof with respect to the database. The database 240 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). The database may have back-up capability built-in. Communications with the database 240 may be over a network, such as the network 230, or communications may be over a direct connection between the database 240 and the server 220. Data may be transmitted and/or received from the database 240. Data transmission and receipt may utilize cabled network or telecom connections such as an Ethernet RJ15/Category 5 Ethernet connection, a fiber connection, a traditional phone wireline connection, a cable connection or other wired network connection. A wireless network may be used for the transmission and receipt of data.

The system 200 may include a portable electronic device 250. The portable electronic device 250 may be more than one portable electronic device. The portable electronic device 250 may be associated with a user. The user may interact with the portable electronic device through various input means. For example, the portable electronic device 250 may have a display screen to convey information to the customer. The display may be a color display. For example, the display may be a Liquid Crystal Display (“LCD”). The display may be a touch screen. The portable electronic device 250 may have one or more input devices associated with it. For example, the portable electronic device 250 may have an alpha-numeric keyboard, either physical or virtual, for receiving input. The portable electronic device 250 may have a QWERTY style keyboard, either physical or virtual. The portable electronic device 250 may have a pointing device associated therewith, such as, for example, a trackball or track wheel. As described above, the portable electronic device 250 may have communication capabilities over both cellular and wireless type networks to transmit/receive data and/or voice communications.

The portable electronic device 250, by way of non-limiting examples, may include such portable computing and communications devices as mobile phones (e.g., cell or cellular phones), smart phones (e.g., iPhones, Android based phones, or Blackberry devices), personal digital assistants (PDAs) (e.g., Palm devices), laptops, netbooks, tablet computing devices, e-readers, or other portable computing devices. These portable electronic devices may communicate and/or transmit/receive data over a wireless signal. The wireless signal may consist of Bluetooth, Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet (TCP/IP) Protocols, or other protocols and/or systems suitable for transmitting and receiving data from the portable electronic device. The portable electronic device may use standard wireless protocols which may include IEEE 802.11a, 802.11b, 802.11g, and 802.11n. Such portable electronic devices may be Global Positioning System (GPS) capable. GPS is a satellite based system which sends a signal allowing a device to define its approximate position in a coordinate system on the earth. That is, the portable electronic device may receive satellite positioning data and display the location on the earth of the portable electronic device using GPS. Other location systems may be used. The portable electronic device 2500 may include one or more computer processors and be capable of being programmed to execute certain tasks.

The portable electronic device 250 may establish communications with the server 220. Communications may be established over the network 240. Upon successful initiation of communications between the portable electronic device 250 and the server 220, data may be exchanged between the device 250 and the server 229. Data may be transmitted from the portable electronic device 250 to the server 220. Data may be transmitted from the server 220 to the portable electronic device 250.

According to some embodiments, the portable electronic device 250 may interact with the displays 210 and 215. Through the displays 210 and 215, the portable electronic device 250 may interact with the server 220 or other parts of the system 200.

The system 200 may have other systems 260 associated therewith. These other systems 260 may include various data collection and support systems used by the entity to carry out its functions.

It should be appreciated that the server may interact with other parts of the system 200, such as the displays 210 and 215 and the portable electronic device 250, as well as the processing module 140 and the other systems 160. The server 180 may be a single server or it may be multiple servers. The server 180 may server a variety of roles in the system 100.

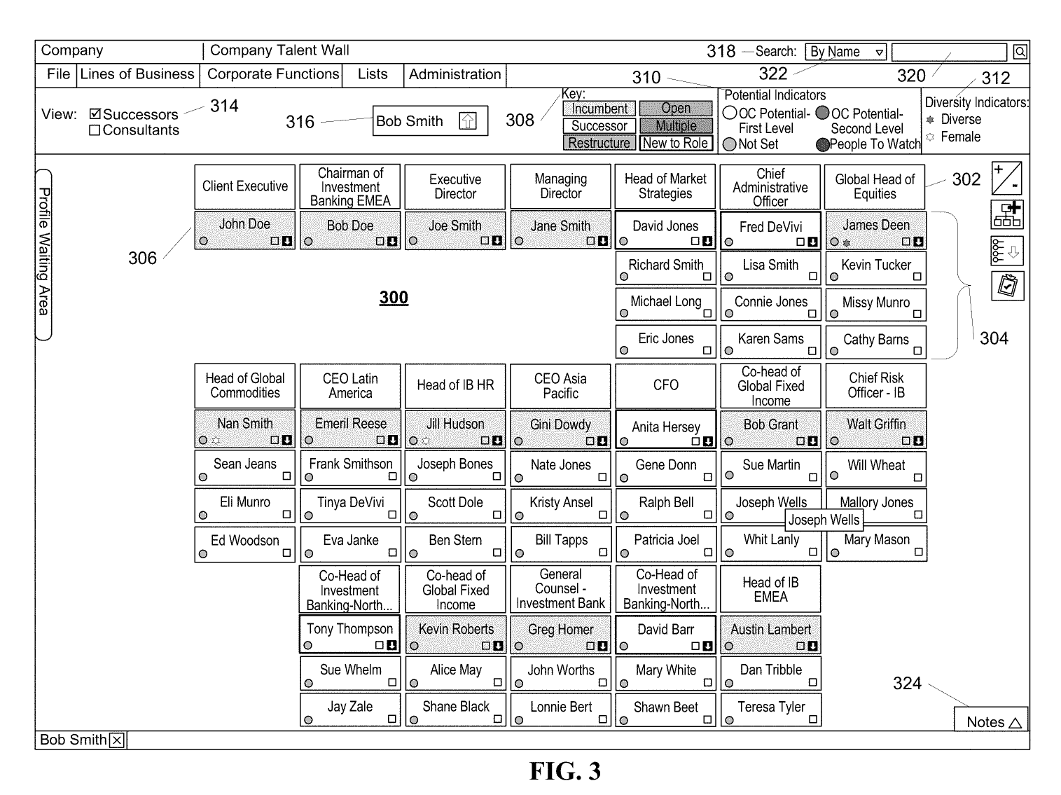

FIGS. 3 through 10 show exemplary displays for an application for collaborative succession planning in accordance with exemplary embodiments. For example, the displays may be of a talent wall application. These screens may be used with a computing device as described above. It should be appreciated that such user screens are meant to be exemplary only and that the screens may have more or less features than depicted herein and be arranged in different manners than shown. It should further be appreciated that the information depicted in the following Figures is exemplary only and presented for illustrative purposes. For example, the entity organization shown and the key, potential indicators, and diversity indicators are meant to be exemplary only and are presented to illustrate the embodiments described herein.

Each display may be an electronically produced screen that may be display on one or more displays or screens as described above. The displays may each span a single display screen or may span multiple display screens. According to some embodiments, the display may be on a portable electronic device. The displays may be color.

FIG. 3 shows a display screen depicting an organizational chart 300. The chart may be organized as shown in FIG. 3. A series of positional identifiers 302 may indicate the level of the group 304 listed below it. Each person may have a box 306. The box 306 may be coded according to a key 308, a potential indicator 310, and a diversity indicator 312 as shown. In this manner, a reviewer of the chart 300 may determine the status of the people shown therein. Each box 306 may be selected and moved around the chart 300. A drop and drag type interface may be used. For example, a box 306 may be selected and dragged to another location in the chart 300. In this manner, changes may be affected to the chart 300 and its alignment of people in an organization. Any changes may be reversible. Changes may be saved to the chart 300.

A view selection 314 may determine the type of view of the chart. For example, the view selection 314 has the “successors” option checked. A name box 316 may be used to indicate the person for whom successors are being reviewed. For example, the name box 316 may represent an incumbent in a position and the organizational chart 300 represents the lists of successors for that person. A search tool 318 may be provided. The search tool 318 may enable searches by entering text into a box 320. A filter 322 may be applied to search certain categories. The filter 322 may be a drop down type menu from which an option is selected. For example, the filter 322 may be set to search by name. The organizational chart 300 may have a notes option 324. The notes option 324, once selected may cause a notes area to appear allowing the entry of text notes.

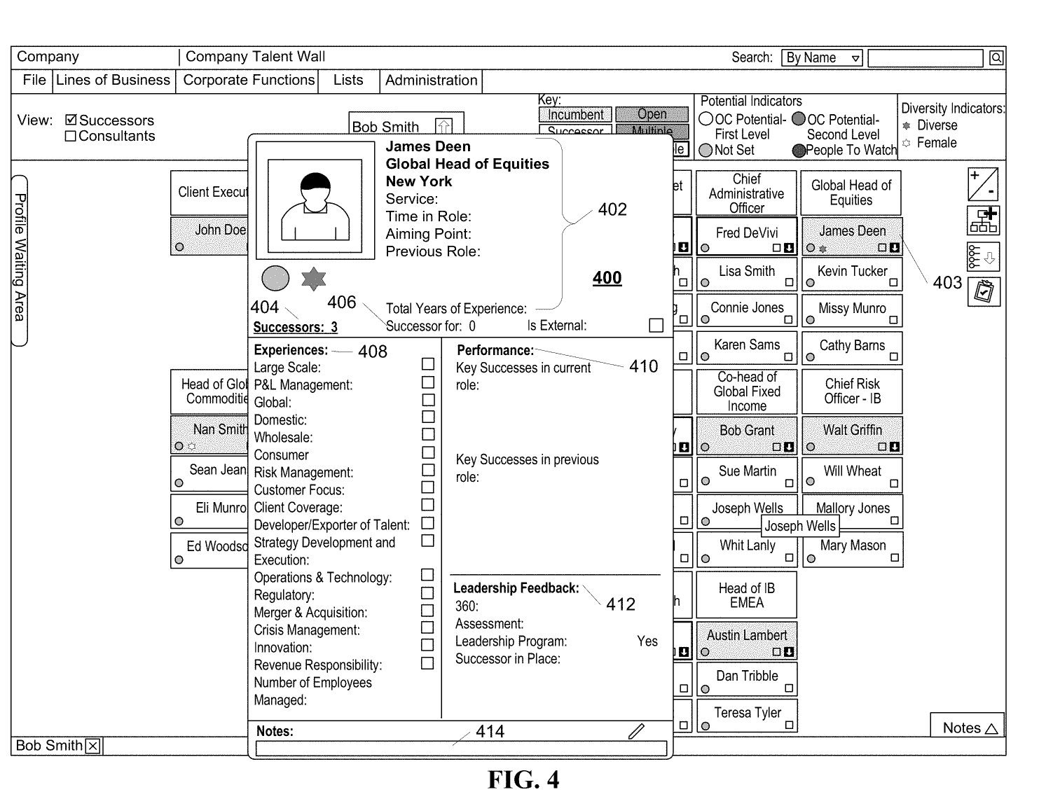

FIG. 4 shows a view of a information card 400 for an individual. The information card 400 may resemble a “baseball” type card. The information card 400 may have a fact section 402 that has information about the person. For example, the person's name, position, location, service, time in role, aiming point, previous role, total years experience, any potential and diversity indicators, and a photo may be included in the fact section 402. The information card 400 may be accessed by selecting that person from the organizational chart. For example, James Deen's box 403 may be selected from the organizational chart. The selection may be made through the organizational chart through a selection means. For example, a cursor or other indicator may be placed over the person's box and a button or key actuated to select the person. The box may be “clicked-on.”

To facilitate succession planning, the information card 400 may include a indicator 404 of the successors to that person's position. An indicator 406 may indicate positions for which the person is a successor. The indicators 404 and 406 may be links capable of being actuated to bring up a listing of either the successors to the person or the person for whom the selected person is a successor to. When actuated, these links may bring up information cards for those individuals. An lower section of the information card may include additional information. An experiences section 408 may list the person's experience against a list of set criteria. A performance section 410 may list performance information. A leadership feedback section 412 may list leadership information. A notes section 414 may provide for text notes to be entered onto the information card 400.

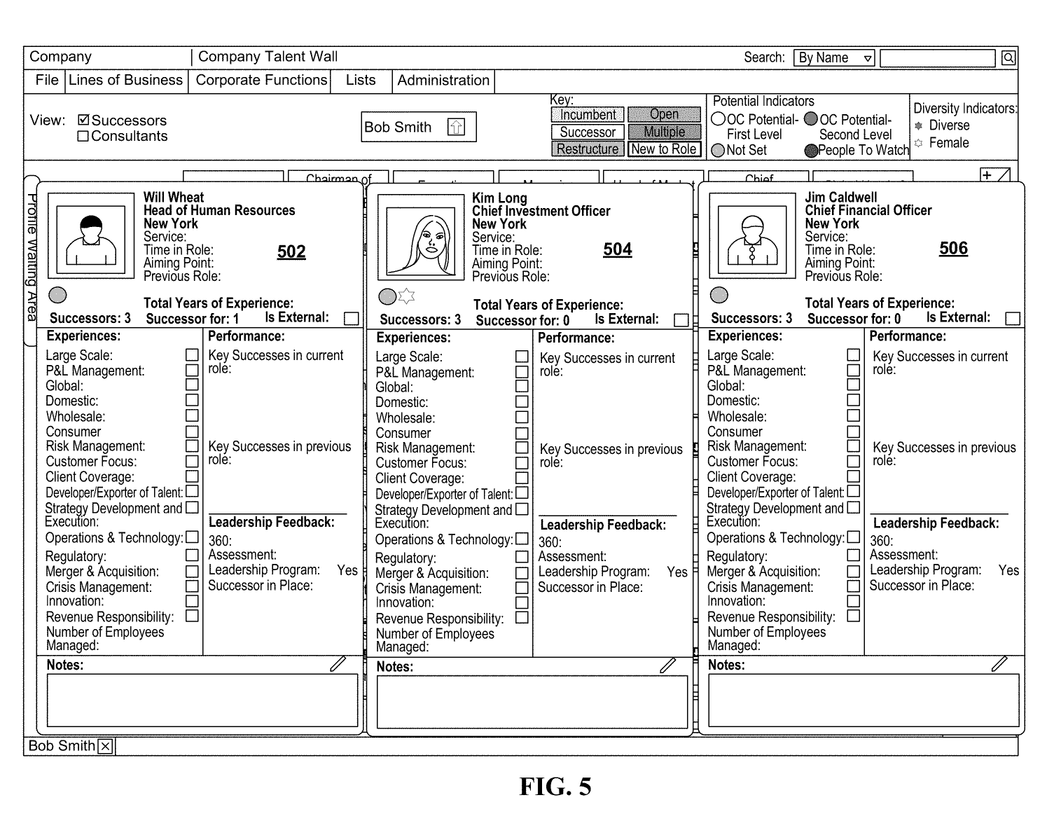

FIG. 5 depicts a display screen with three information cards 502, 504, and 506. These information cards may be displayed side-by-side as depicted to facilitate comparison of the information contained therein. The information cards 502, 504, and 506 may be configured as described above for FIG. 4 with respect to the information card 400. The information cards 502, 504, and 506 may be selected for appearance by selecting the individual boxes of the desired individuals or by performing a search for individuals. The search may be performed searching for individuals meeting certain criteria. According to some embodiments, the information cards 504 and 506 may appear by selecting the successors link 404 on the information card 400, For example, the information card 502 may be an initially selected person. The successors link may be activated and the information cards 504 and 506 may then be displayed. It should be appreciated that there are other ways to display and select multiple information cards. Further, the three information cards 502, 504, and 506 are shown as an example and more or less information cards may be selected and displayed. According to some embodiments, the information cards 502, 504, and 506 may be resizable and movable on the display. For example, the order of the information cards, such as from left to right, may be altered through a drop and drag type action.

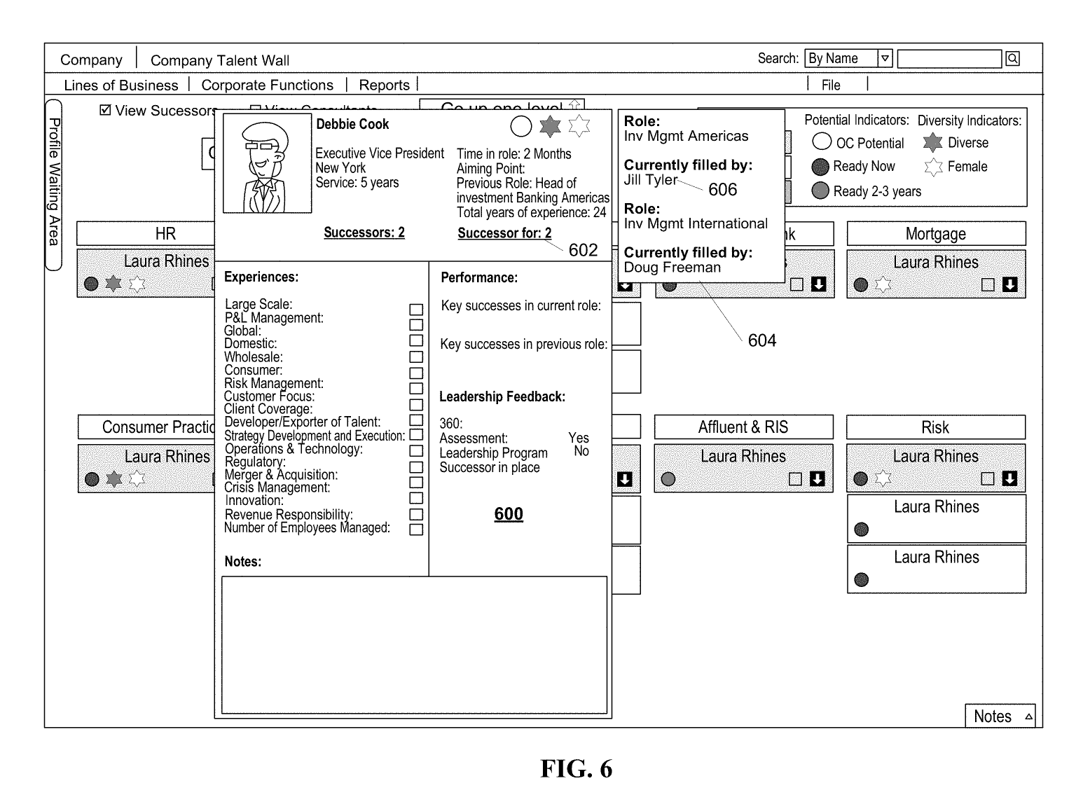

FIG. 6 shows a view of an information card 600. As described above, the information card may have a “successor for” indicator 602. The successor for indicator 602 may be a link. When actuated, the link may cause a successor for window 604 to appear. For example, the information card 600 lists two in the successor for indicator 602, so when the successor for indicator 602 is selected a successor for window 604 may appear as shown in FIG. 6. It should be appreciated that the successor for window may be arranged or positioned in a different manner than shown. The successor for window 604 may contain information relating to the positions for which the person in the information card 600 is a successor for. The successor for window 604 may have links embedded in its information such that the information, such as a person 606, may be clicked-upon or otherwise selected causing an information card for that person 606 to appear upon the display.

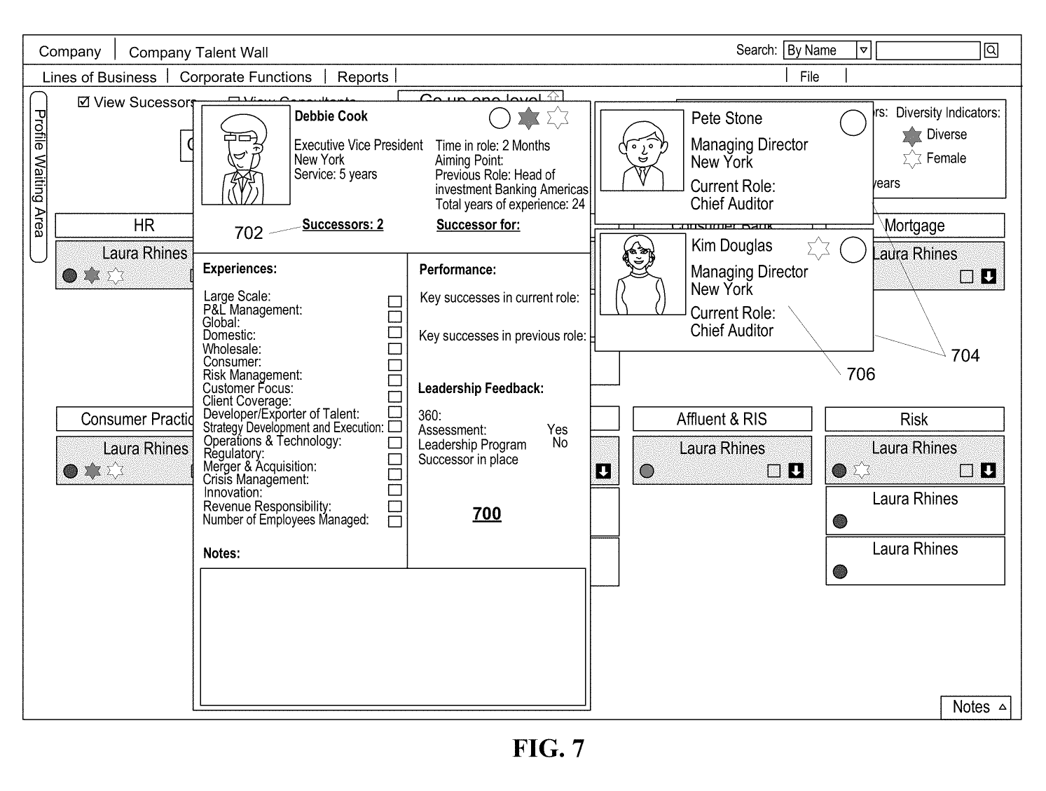

FIG. 7 shows a view of an information card 700. As described above, the information card may have a “successors” indicator 702. The successors indicator 702 may be a link. When actuated, the link may cause a successors window or windows 704 to appear. The successor window(s) 704 may appear beside the information card 700 as shown in FIG. 7. For example, the information card 700 lists two successors, so when the successors indicator 702 is selected two successors windows 704 may appear as shown in FIG. 7. The successor window(s) 704 may contain information relating successor for the person shown in the information card 700. It should be appreciated that the successors windows may be arranged or positioned in a different manner than shown. The successor window(s) 704 may have links embedded in its information such that the information, such as a person 706, may be clicked-upon or otherwise selected causing an information card for that person 706 to appear upon the display.

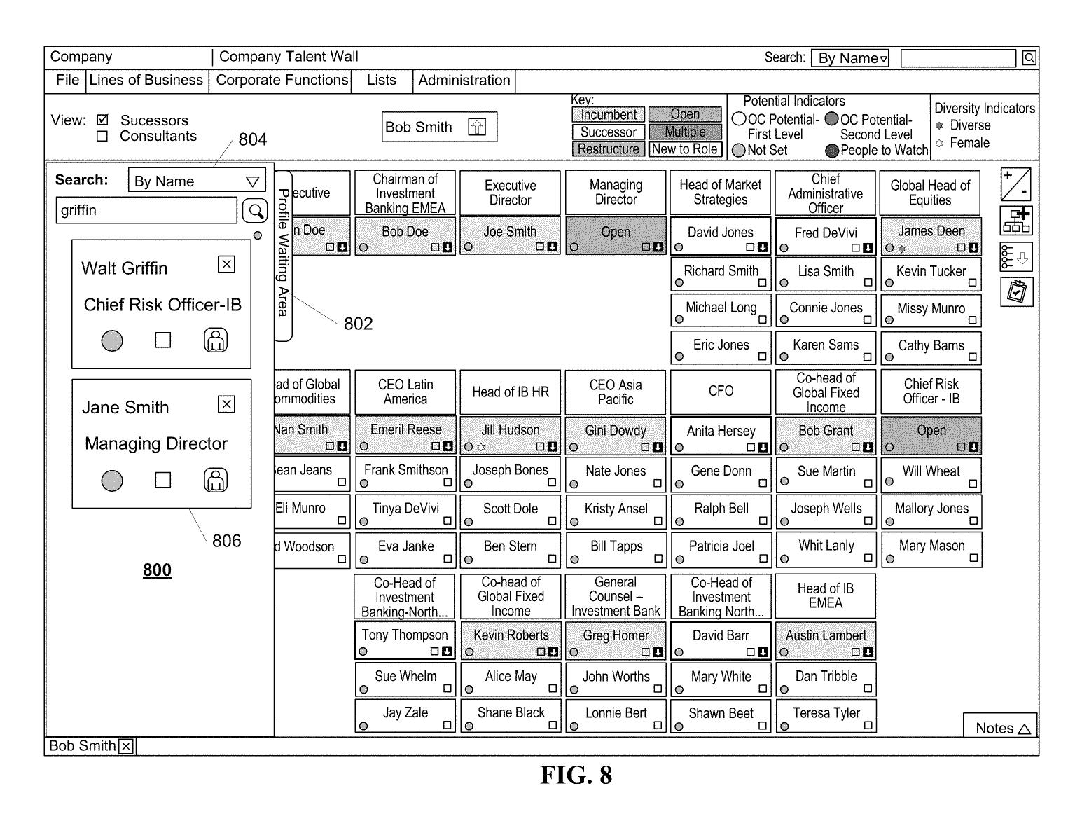

FIG. 8 shows a profile waiting area 800. The profile waiting area may be a parking type area for profiles awaiting review. The profile waiting area by be a pull-out type window or tab that is actuated by selecting the “Profile Waiting Area” tab 802. The profile waiting area may be a box or frame on the display.

The profile waiting area 800 may have a search capability 804 similar to that described in FIG. 3. Once a search is conducted, the boxes 806 may be displayed in the profile waiting area 800. The boxes 806 may be selected and then the appropriate information card may be displayed on the screen. Multiple results may be selected enabling the display of multiple information cards. For example, multiple information cards as shown in FIG. 3 may be displayed.

The profile waiting area 800 may serve as a “parking area” for people or profiles. When moving personnel around the organizational chart, people may be dragged and dropped into the profile waiting area as a holding location during organizational changes. In some situations, people may automatically be moved to the profile waiting area. For example, if a person is displaced in a chart by moving a second person into their position, that first person may be automatically moved into the profile waiting area. Similarly, if a position is eliminated or deleted from the organizational chart, then an option may be presented to move all people who were under that position into the profile waiting area. Alternatively, these people may be automatically moved into the profile waiting area when a position over then is deleted. The profile waiting area may be accessed and hidden by selecting the profile waiting area tab 802.

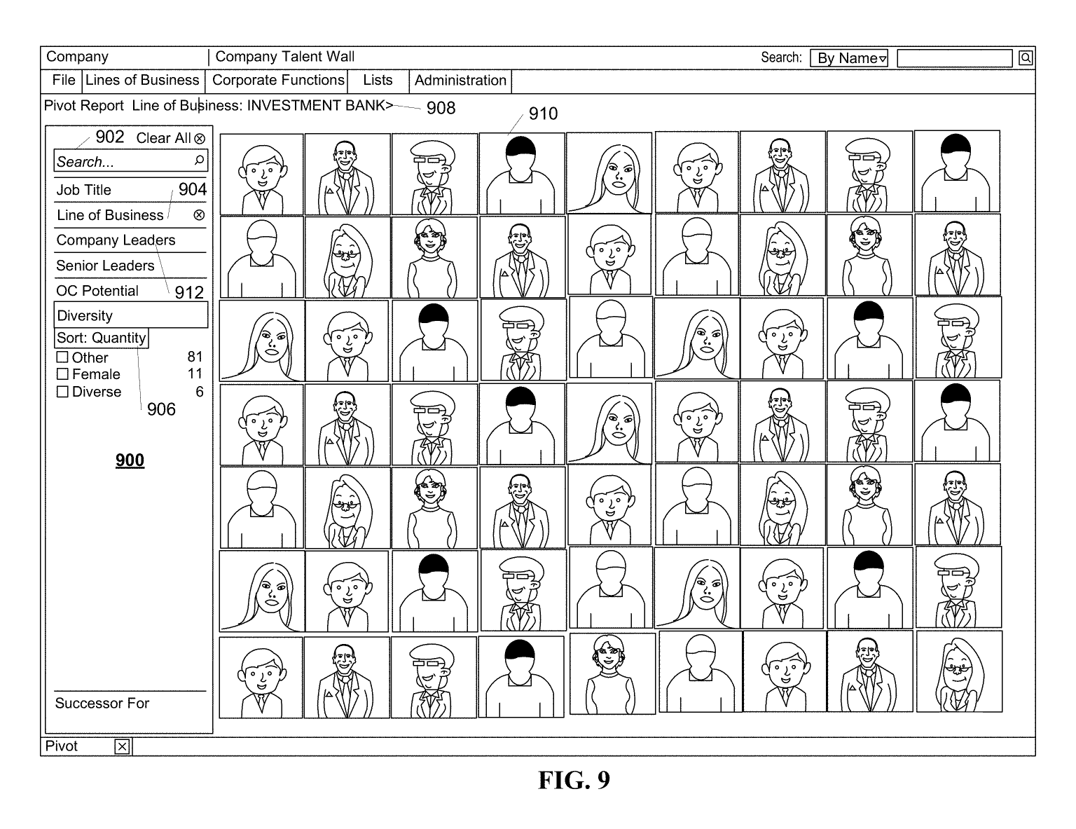

FIG. 9 shows a display with a personnel report. This display may be generated as part of a report. For example, a selection on the display may be made to generate a report. Upon such selection, a tab, frame, box, or window may appear. For example, box 900 may appear and allow selection of the report information. The box 900 may have a search box 902. Search criteria 904 may be specified. For example, the search may be by line of business as shown in FIG. 9. The search results may be filtered by various criteria 906, such as quantity, gender, and diversity. A drop down type selection may be used for the filter and/or check boxes may be used to identify the selections. Header information 908 may identify the type of report and the content of the results. For example, a line of business search was conducted for the investment bank department of an entity. The results may be displayed in the form of one or more photographs 910 of the personnel meeting the search report criteria. There may be one or more results returned from the search. For example, multiple photographs 910 may be displayed. The photographs may each be selectable such that upon selection, an information card may be displayed as described above.

According to some embodiments, the criteria 904 may represent dynamic reports that may be generated through selection of the option. For example, company leaders may be selected. Upon selection, a report of company leaders may be generated. Other options, such as dynamic report categories, may be selected to generate the dynamic reports.

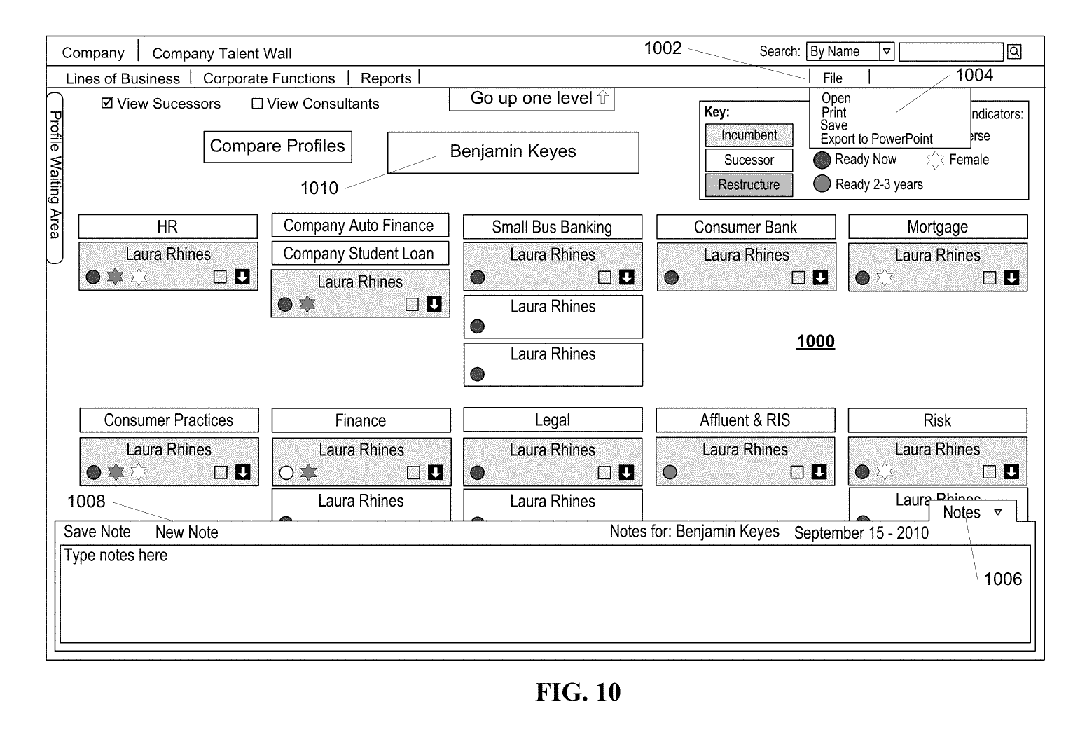

FIG. 10 shows a display 1000. The display 1000 may depict an organizational chart as shown. A file option 1002 may be located on the display 1000. The file option 1002 may be located as shown. It should be understood that the file option 1002 may be located in other locations on the display 1000. The file option 1002 may be selected. For example, the file option 1002 may be clicked upon using a cursor or other interface selection tool. Upon being selected, a file options menu 1004 may appear. The file options menu 1004 may present a number of selections. For example, the file options menu 1004 may present options to open, print, save, and export to PowerPoint (or another file format). It should be appreciated that other options may be presented. Upon selection of an option from the file options menu 1004, another menu may appear in some cases allowing further selection of options for the selected action. The action may be executed upon the organizational chart displayed upon the display 1000. The display 1000 may have a notes option 1006. This notes option 1006 may appear as a tab at the bottom of the screen as depicted in FIG. 3. When selected, the notes option 1006 may cause a notes window 1008 to appear. The notes window 1008 may appear by sliding upward from the bottom edge of the display. In the notes window 1008, textual notes may be entered and saved. These notes may be associated with the person 1010 indicated at the upper portion of the display 1000.

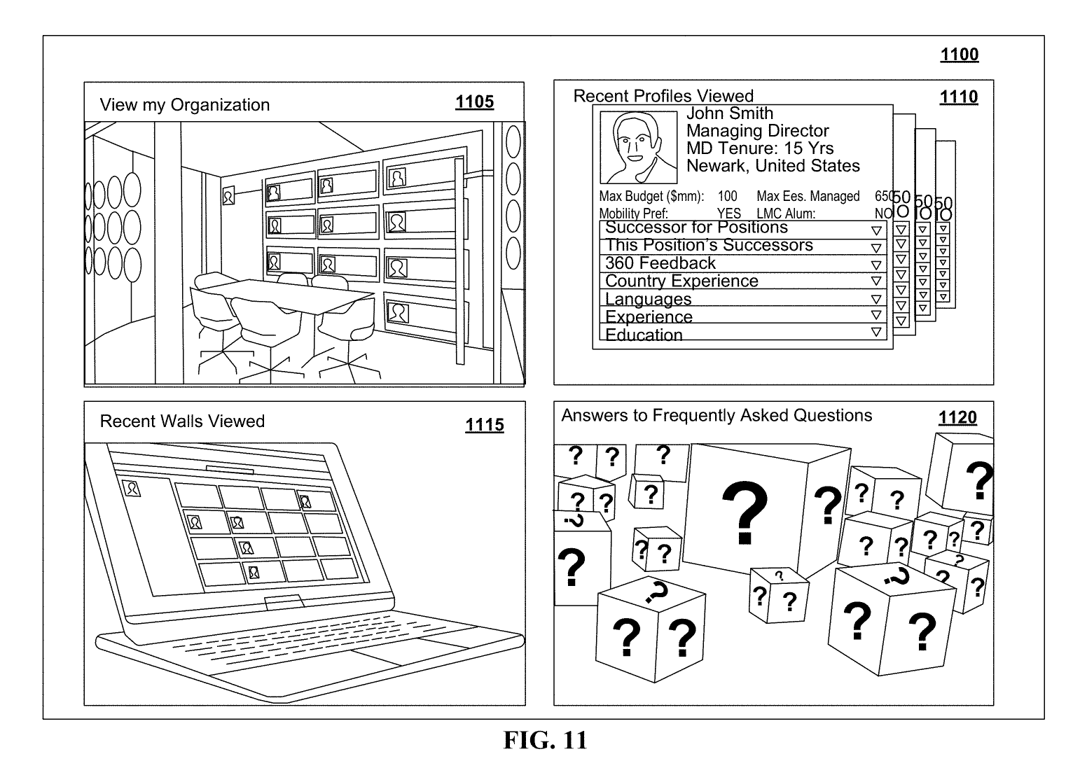

FIG. 11 is an exemplary illustration of a home page. According to an embodiment, home page 1100 may be an initial display screen of the system and may be arranged to include selectable tiles. For example, home page 1100 may be displayed as a default screen upon initiation of the collaborative succession planning application. As shown in FIG. 11, tiles 1105, 1110, 1115, 1120 may be included in the home page 1100. A larger of fewer number of tiles may be provide as is necessary and/or desired.

Each tile is respectively associated with themed groups of other display screens provided by the system. A theme may be a topic, or other identifier, used to organize the layout of accessible display screens provided of the system. In the exemplary screen provided in FIG. 11, home page 1100 includes tiles which correspond to the themes “View my Organization”, “Recent Profile Viewed”, “Recent Walls Viewed”, and “Answers to Frequently Asked Questions”. These themes are exemplary only, and other themes may be presented in addition to, or in place of, these tiles in FIG. 11 as is necessary and/or desired.

In one embodiment, the tiles and arrangement of home page 1100 may be customized by the user (e.g., a reviewer), by management, automatically based on historical usage (e.g., the tile that is selected most often is presented in the upper left corner), etc.

In an exemplary embodiment, a user input device may be employed to select a themed tile, and launch a subsequent display screen predetermined to correspond to the themed group. For example, “Recent Walls Viewed” tile 1115 may list the names of personnel with wall display screens that the reviewer has recently viewed in previous sessions with the system. The list may display a predetermined number of walls, such as the last five walls the reviewer recently viewed. In one embodiment, when the reviewer clicking on a listed wall in “Recent Walls Viewed” tile 1115, electronically retrieves and launches the wall display screen for the selected individual. In another embodiment, when the reviewer clicks on “Recent Walls Viewed” tile 1115, the reviewer will be presented with information cards for the predetermined number of most recent walls viewed.

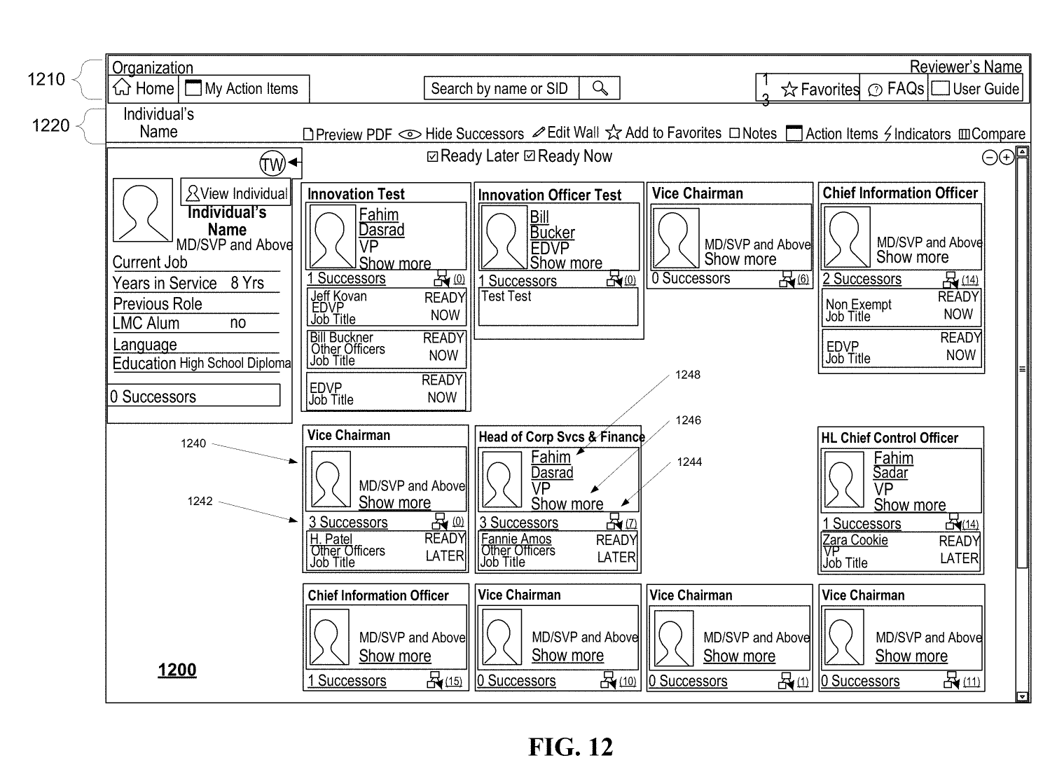

FIG. 12 shows an exemplary display screen depicting a wall 1200 for an individual, that may be include, for example, personnel employed by the entity. Wall 1200 may be provided as result of receiving a selection input from a reviewer, such as by selecting the “View My Organization” tile depicted in FIG. 11.

In one embodiment, row 1210 of wall 1200 may include the following options: “Home Tab”, which may return the user to a home page, such as home page 1100 depicted in FIG. 11; “My Action Items”, which may list the action items that have been assigned to the user; “Search Function”, which may permit the user to search for and find an individual by name or subscriber ID (‘SID”); “Favorites”, which may identify saved walls and/or profiles; “FAQs”, which links to “Frequently Asked Questions”; and “Reviewer's Name”, which displays the name of the reviewer that is logged in. Any or all of these items may be presented as is necessary and/or desired.

Row 1220 of wall 1200 may include “Individual's Name”, which displays the name of the individual whose wall 1200 is being viewed; “Preview PDF”, which generates a printable file of wall 1200; “Hide Successors”, which toggles on/off the display of individuals identified as successors on wall 1200; “Edit Wall”, which allows the user to edit wall 1200; “Add to Favorite”, which allows the reviewer to add this wall to his or her favorites; “Notes”, which may allow the reviewer to add or view the notes on wall 1200; “Action Items”, which may allow the review to add action items to wall 1200, “Indicators”, which may allow the reviewer to add indicators to wall 1200; and “Compare”, which may allow the reviewer to compare multiple profiles, etc. Other features may be provided as necessary and/or desired.

The “Edit Wall” feature may allow the reviewer to make several edits to wall 1200, including, for example, adding a new position, adding a matrix relationship, editing a name of the position for the talent wall only (e.g., no changes are made in related human resources software, databases, etc. such as PeopleSoft); adding successors that are Ready Now or Ready Later; hiding or reordering positions on wall 1200 (e.g., by selecting a hide icon, selecting an arrow, etc.); adding favorites; adding notes; adding action items; adding indicators; comparing multiple profiles simultaneously, etc. Other editing features may be provided as necessary and/or desired.

The ability to make some or all of these edits may depend on an authority level of the reviewer.

In one embodiment, the reviewer may select whether to display successors that have profiles that are “Ready Now”, “Ready Later”, or both by selecting the appropriate checkboxes.

Summaries 1240 may include successor indicator 1242 that may identify the number of individual(s) designated as successors to the role.

Summaries 1240 may further include “Drill-down” icon or indicator 1244 that may provide the user with the ability to view further down in the organization by viewing direct reports; “Show more” icon or indicator 1246 that may expand the user box and provide summarized information for the individual; and “Individual's Name” icon or indicator 1248 that may present the person's detailed profile.

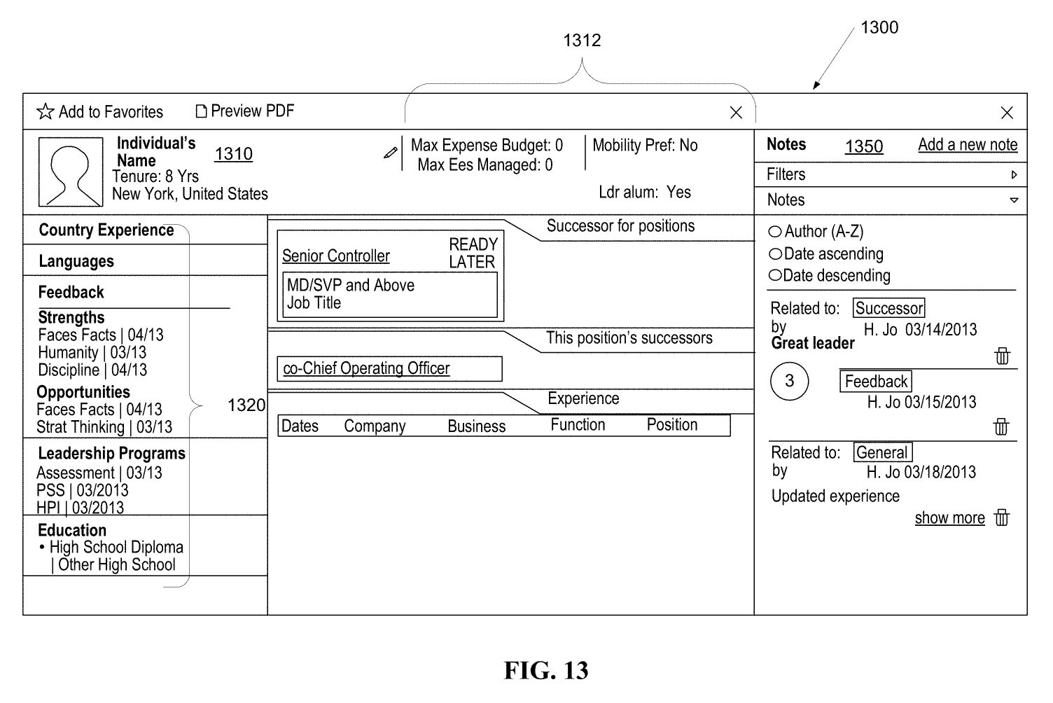

Referring to FIG. 13, an exemplary profile 1300 is provided according to one embodiment. In one embodiment, profile 1300 may be opened by selecting “Recent Profiles Viewed” tile 1110 in FIG. 11, by searching for a profile, by selecting a profile from the managers wall, such as in FIG. 12, etc.

In one embodiment, profile 1300 may include data provide by the individual and from external systems/databases. For example, the individual may provide information for his or her profile 1300; external systems/databases, such as PeopleSoft, may provide data to profile 1300; human resources personnel, management, etc. may provide data to profile 1300, etc.

Profile 1300 may include, for example, the following options: “Add to Favorites”, which will save the current profile to the reviewer's favorite tab; and “Preview PDF”, which generates a PDF of the displayed information, and any other options as is necessary and/or desired.

In addition, profile 1300 may identify the individual's name 1310 whose profile 1300 the reviewer is viewing. Profile 1300 may further provide individual information 1312, such as the largest expense budget managed by the individual; the largest number employees managed by this individual; the individual's mobility preference, or desire to work in a different location; whether the individual attended a leadership or other course; etc. Individual information 1312 may vary depending on the organization/entity, the individual's role, etc., as is necessary and/or desired.

Profile 1300 may further provide the individual's experience 1320. For example, experience 1320 may include the individual's country experience, which may identify if the individual had previous work experience in countries other than the current job location; the individual's ability to read, write or speak in various languages; the individual's top and bottom leadership attributes; a list of senior level development activities and programs completed by the individual;′ and the educational history of the individual. The experience that is provided may vary depending on the organization/entity, the individual's role, etc., as is necessary and/or desired.

Profile 1300 may also identify whether the individual is a ready to be a successor (i.e., “READY”) or is in training to be a successor and will ready at a later time (i.e., “READY LATER”); whether the individual is a successor for any positions and an identity of those positions; the identity of any successors for the individual's position; a list of previous positions held by the individual; etc.

In addition, the reviewer may provide notes in notes section 1350.

In one embodiment, the individual's desire to work in a different location, country experience, languages, education, and experience may be provided by the individual directly or through a portal. The individual's name, position title, officer title (if applicable), tenure, and work location may be provided from external systems/software. Managers, human resources, etc. may provide information on leadership courses, feedback, etc.

In one embodiment, the ability to edit certain fields may be restricted. For example, the expense budget and employees managed may be edited by the individual's direct manager, while the expense budget, employees managed, leadership course alumni status, successor for positions, successors for position, and notes may be edited by the designated human resources partner.

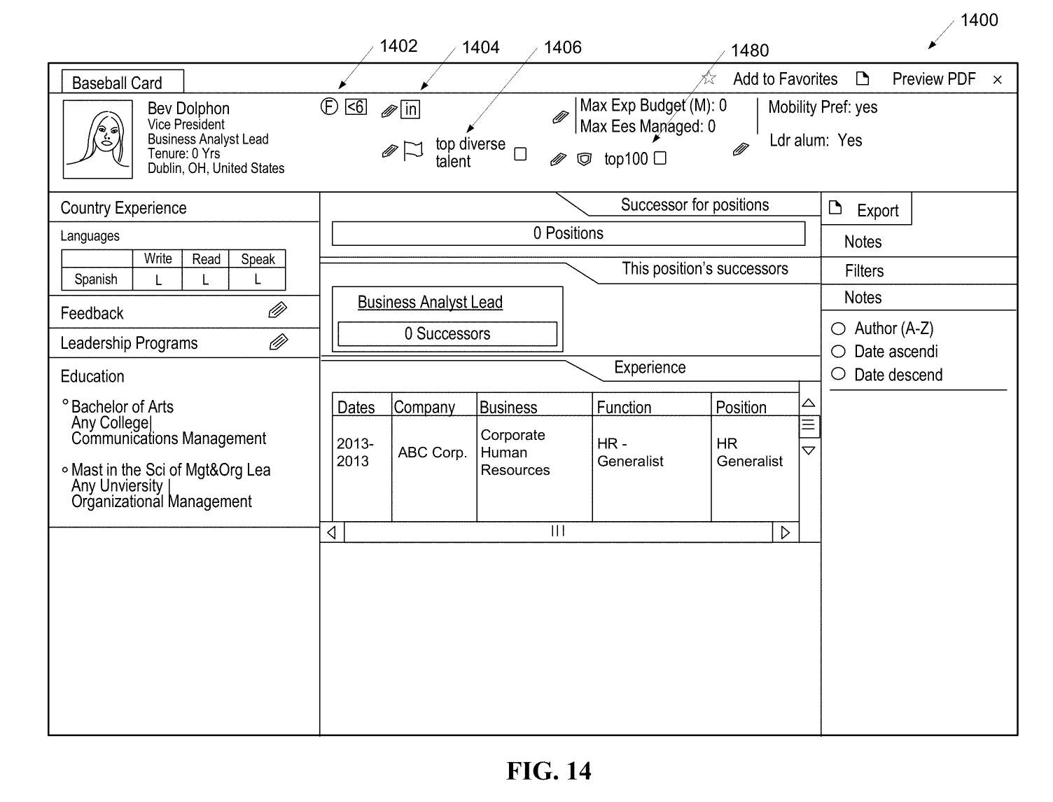

An example profile is provided in FIG. 14. Profile 1400 has a slightly different organization/format than the profile in FIG. 13 and illustrates different ways that information may be presented. Profile 1400 includes addition information, such as, for example, gender indicator 1402 (e.g., “F” for female), link to social media/networking 1404 (e.g., LinkedIn); whether the individual is considered to be “top diverse talent” 1406; whether the individual is a “top 100” employee 1408, etc. Note that the additional information, quantitative values (e.g., top 100 versus top 10, etc.) may vary as is necessary and/or desired.

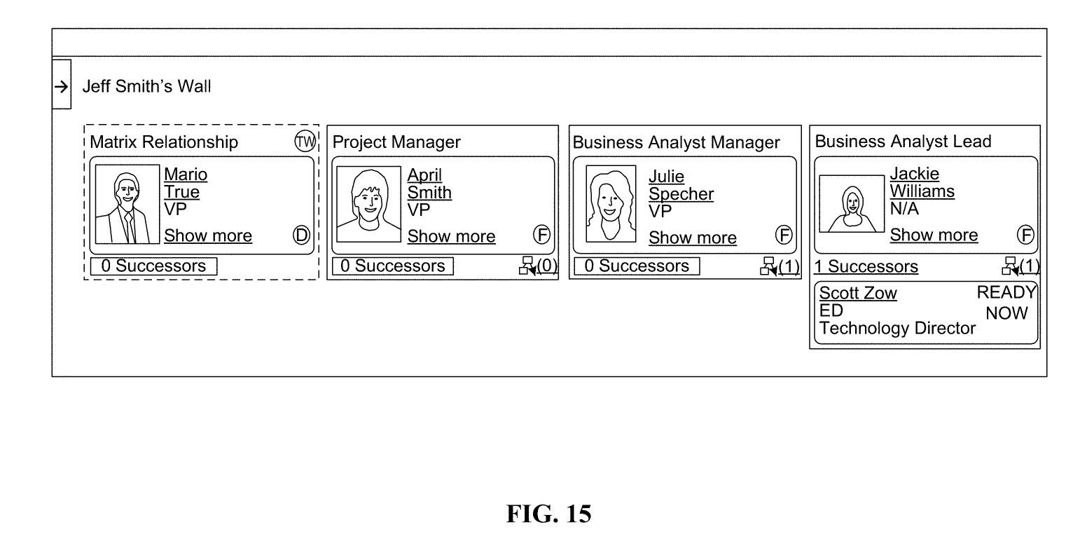

Referring to FIG. 15, an exemplary visual representation of an organization's hierarchy and relationships is provided. In one embodiment, this may be provided as part of the individual's wall, it may be linked to the individual's profile, etc. For Jeff Smith, for example, his matrix relationships (e.g., with Mario True) are provided. Moreover, Jeff Smith's relationships with his project manager, business analyst manager, and business analyst lead are provided. In addition, the number of successors for each individual, as well as an identification thereof, may be provided.

In one embodiment, various filters (e.g., “Ready Now”, “Ready Later”, etc.) may be applied to the hierarchy to provide a customized view.

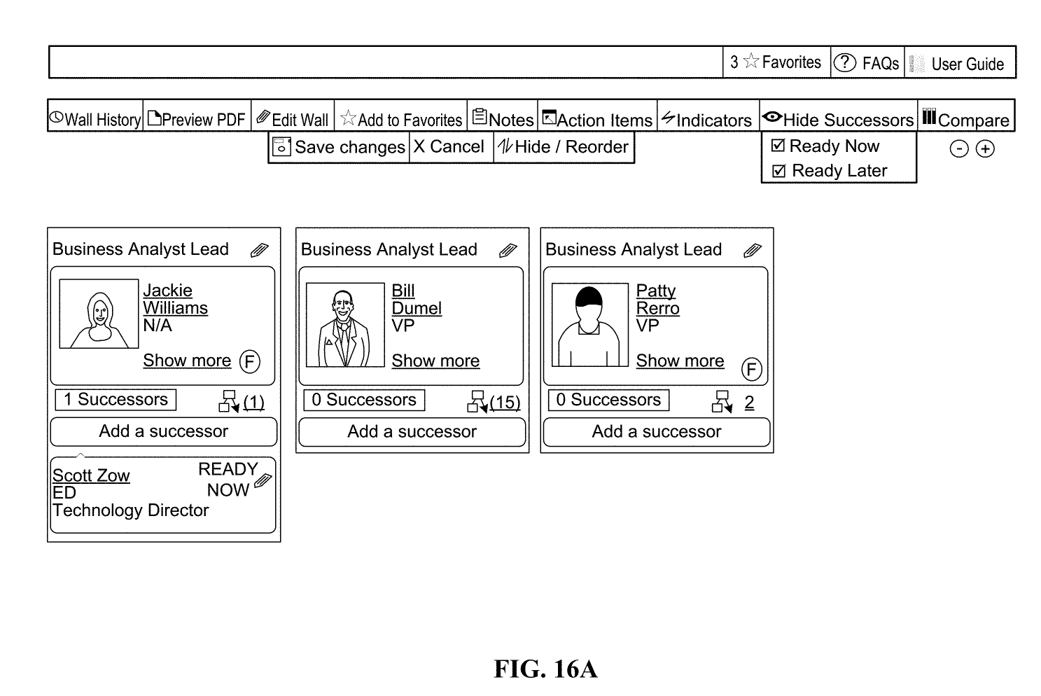

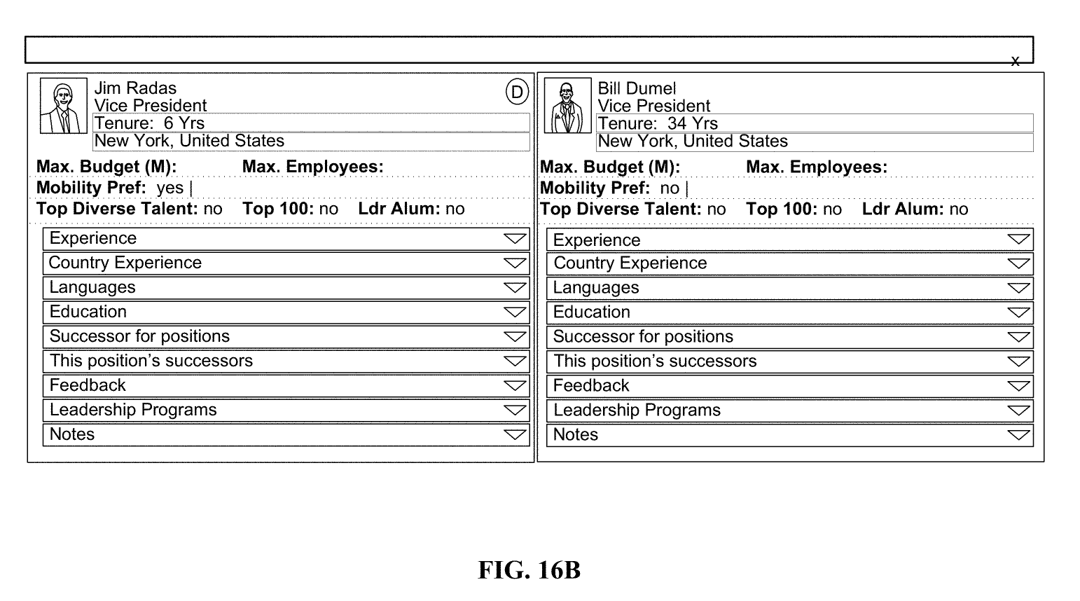

Referring to FIGS. 16A and 16B, an example of visual succession planning is provided. Starting from a wall, the manager may view successors for a position, add successors for a position, remove successors from a position, and/or change successors for a position. For example, for Business Analyst Lead “Bill Dumel”, a successor may be added by selecting “Add a successor” or similar indicator. The reviewer may then enter a name, select a card, etc. and may select the appropriate successor, and may indicate whether the successor is “Ready Now” or “Ready Later.”

A successor may be removed by selecting an icon, such as the “pencil” icon on the name of the successor, and selecting “remove”. The order of succession may be changed by selecting an icon, such as the “pencil” icon on the name of the successor that is to be moved, and by selecting “move” and moving the successor to the desired position.

In one embodiment, the reviewer may enter notes by selecting the “Notes” button, may review multiple individual profiles by selecting two or more individuals and selecting “Compare”, etc. An example comparison of two profiles is depicted in FIG. 16B.

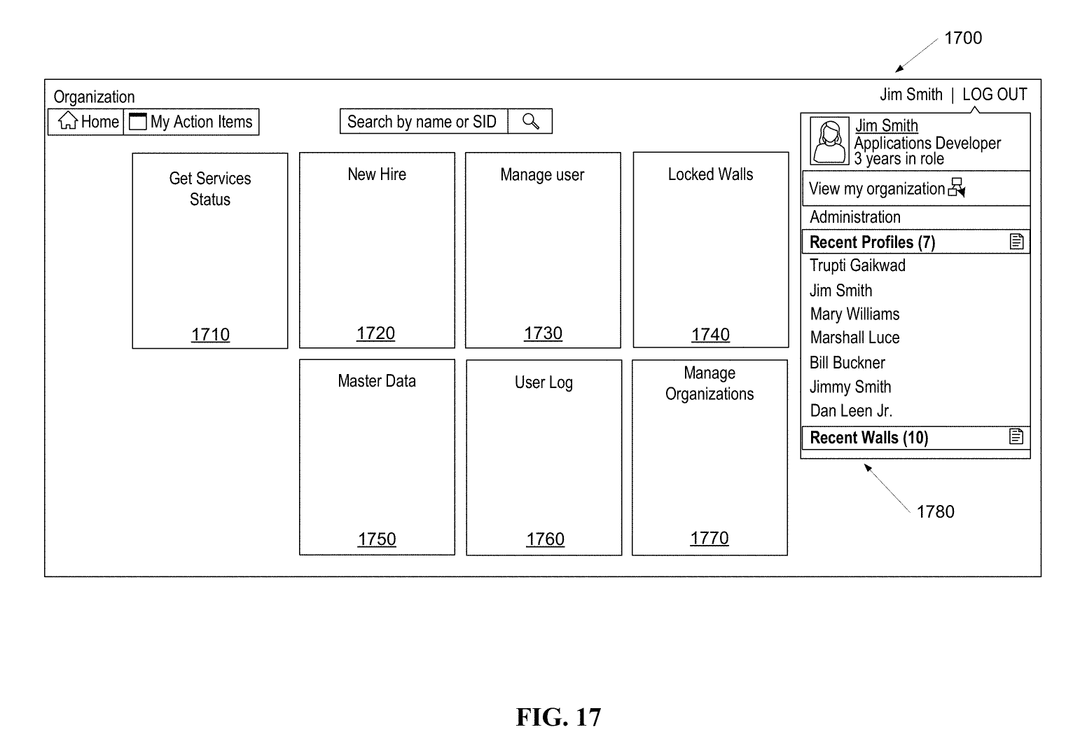

Referring to FIG. 17, an administrative interface is provided according to one embodiment. Interface 1700 may include the following tiles: “Get Services Status” 1710; “New Hire” 1720; “Manage User” 1730, “Locked Walls” 1740, “Master Data” 1750, “User Log” 1760, and “Manage Organizations” 1770. Other links may be provided as necessary and/or desired.

In addition, in one embodiment, the administrator's name and links 1780 may be provided.

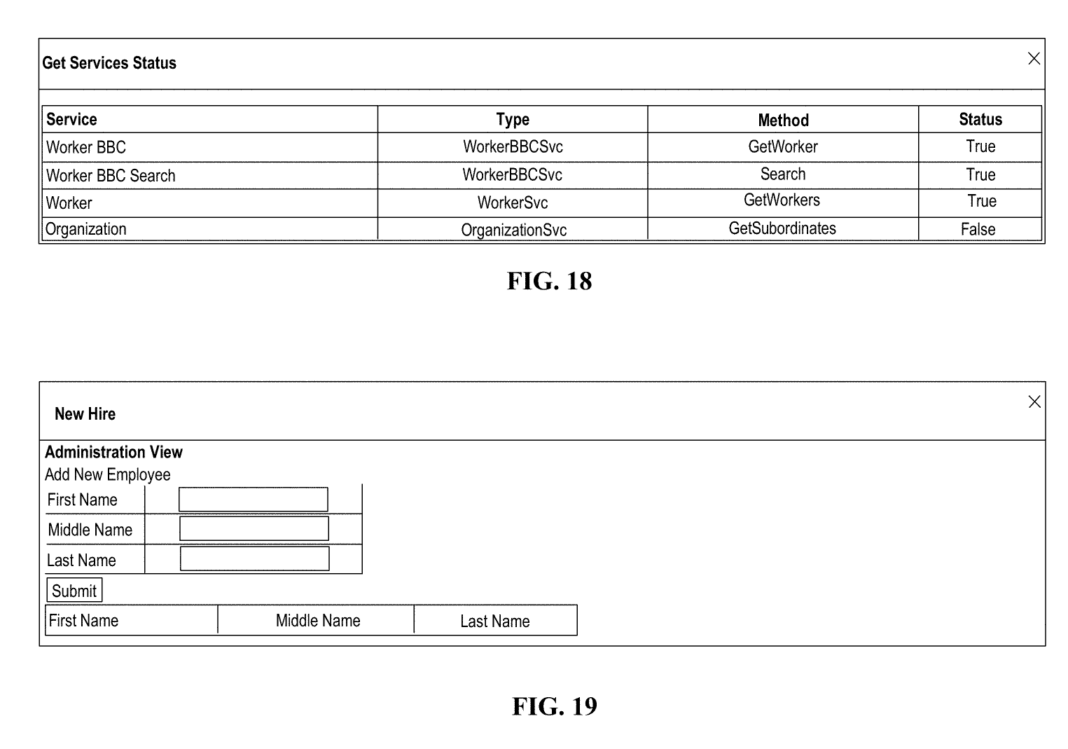

FIG. 18 depicts an example result of selecting “Get Services.”

FIG. 19 depicts an example result of selecting “New Hire.” In one embodiment, the administrator may enter a new employee's first name, middle name, and last name.

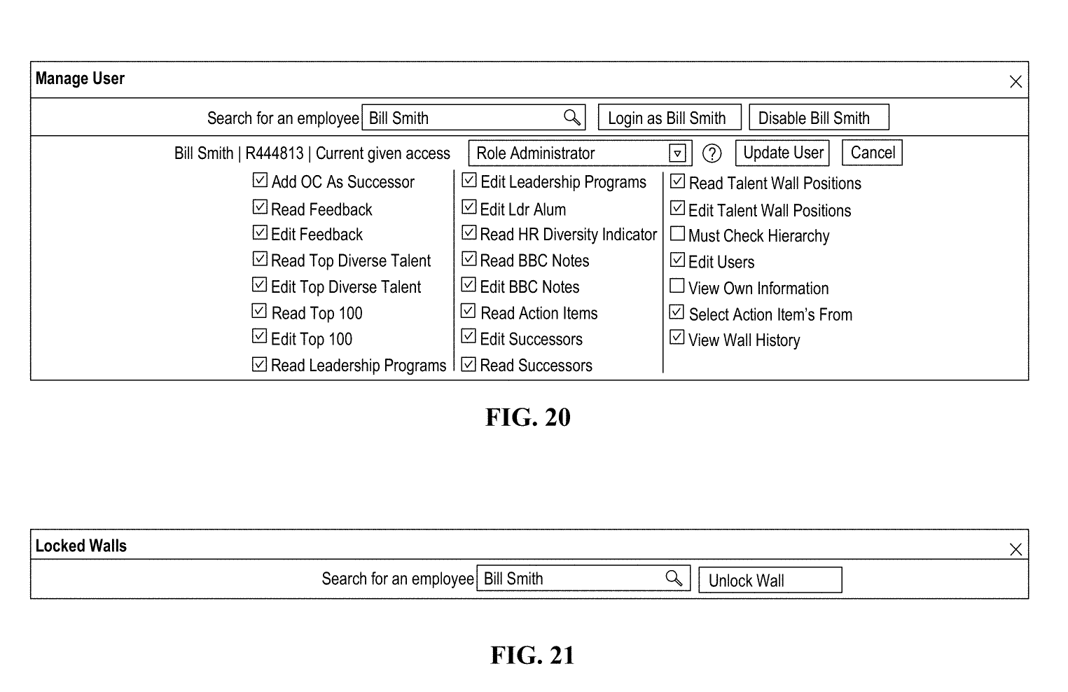

FIG. 20 depicts an example result of selecting “Manage User.” In one embodiment, the administrator may select the reviewer's entitlements. In one embodiment, the entitlements may be selected by a checkbox. Other methods may be used as necessary and/or desired.

In one embodiment, the entitlements associated with a role, such as “Role Administrator”, may be pre-populated according to the default entitlements for that role. In one embodiment, the entitlements may be changed by the administrator as necessary and/or desired. In one embodiment, the entitlements may only be changed if the administrator is authorized to make such changes.

In another embodiment, the administrator may disable the user, login as the user, or perform any other user management as is necessary and/or desired.

FIG. 21 depicts an example result of selecting “Locked Walls.” This may permit the administrator to remove any restrictions that the reviewer may have established.

In one embodiment, the administrator may enter an employee name or other identifier and search for that employee. Upon successful identification of the employee, the administrator may then unlock a wall that may prevent the employee from viewing certain data.

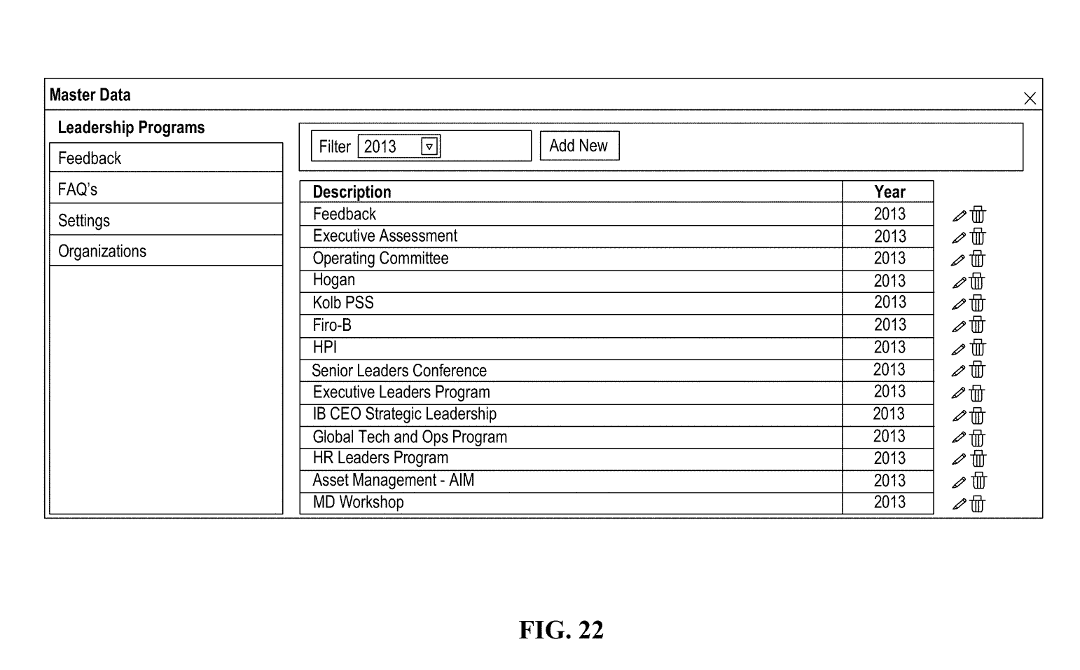

FIG. 22 depicts an example result of selecting “Master Data.” In one embodiment, the master data interface may allow users, such as administrators, the ability to control the content that may display for certain selectable field values. In one embodiment, it may also allow the user to control application settings, organizational settings, etc.

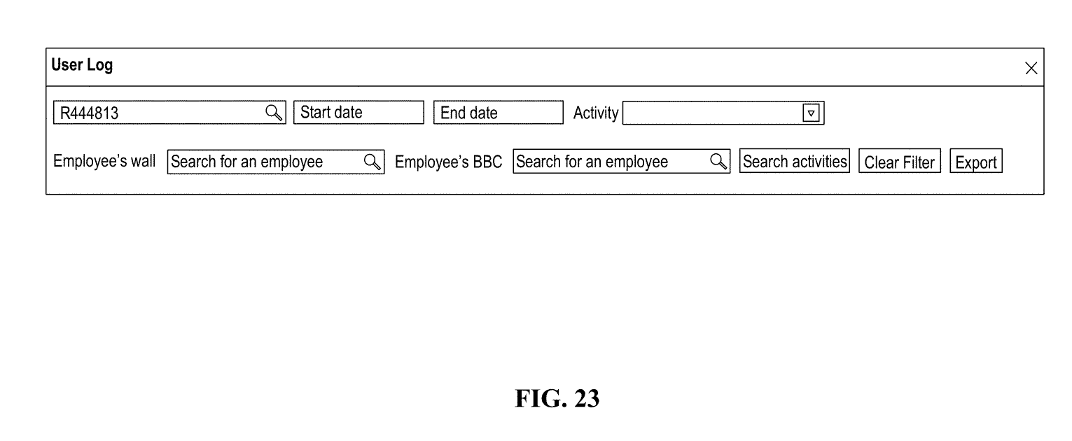

FIG. 23 depicts an example result of selecting “User Log.” In one embodiment, the user log interface may allow users, such as administrators, to search for and view user activity against talent walls and user profiles within the application.

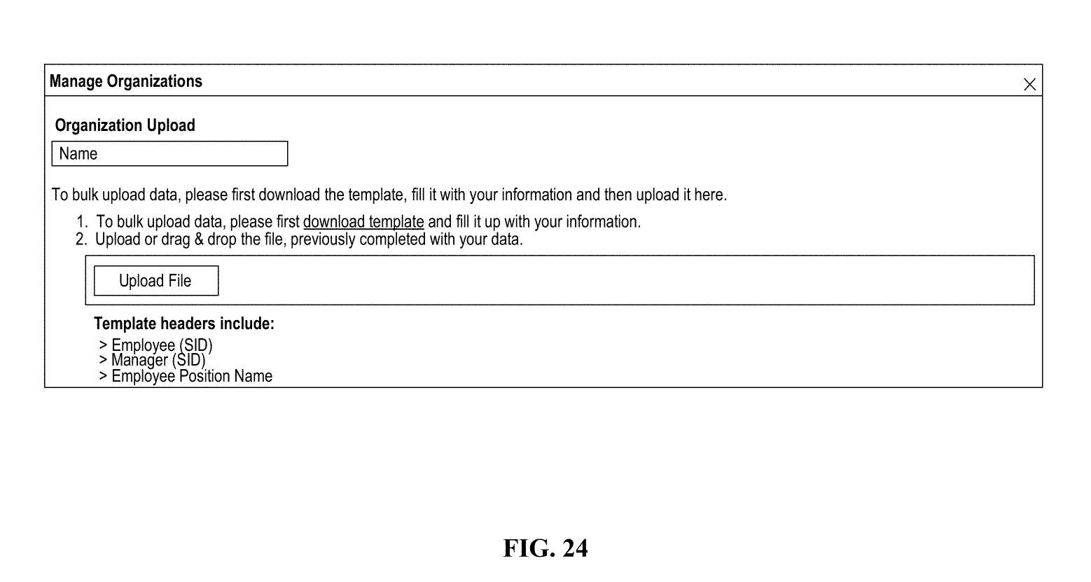

FIG. 24 depicts an example result of selecting “Manage Organizations.” In one embodiment, an administrator may upload information regarding an organization that has be entered into a template.

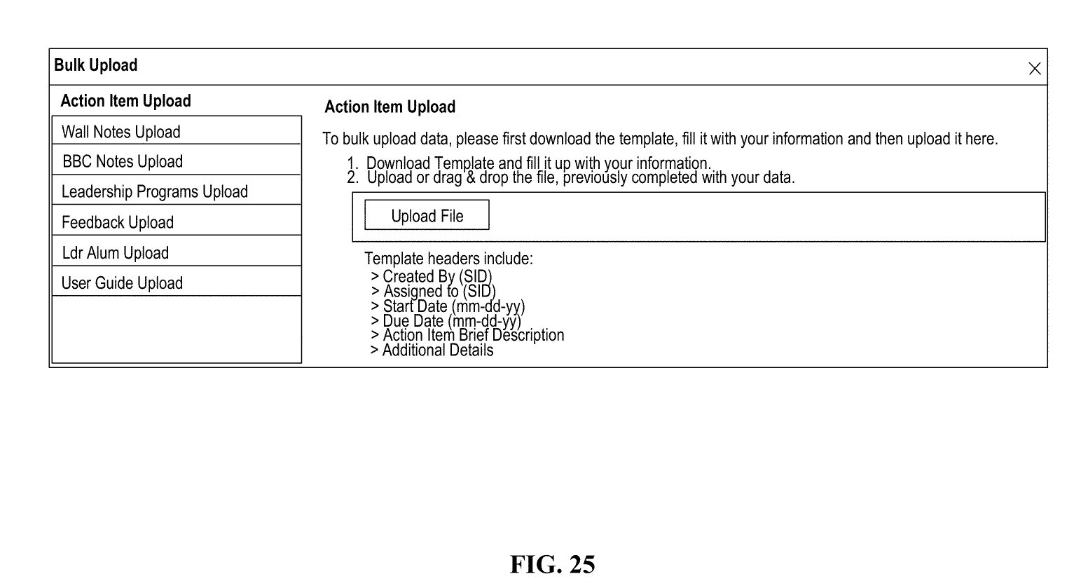

FIG. 25 depicts an example of the “Bulk Upload” interface. In one embodiment, the administrator may quickly upload files for an individual, a group of individuals, etc. In one embodiment, the information may be entered into a template first, and then uploaded.

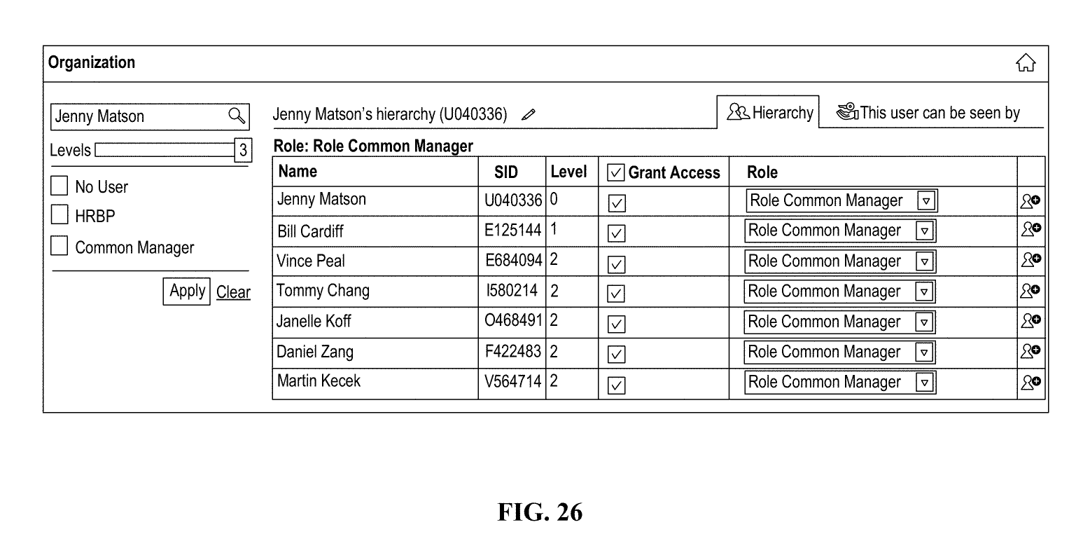

Referring to FIG. 26, an interface for the editing of a hierarchy is provided. In one embodiment, the administrator may view the individuals in his or her hierarchy and may assign them roles that may then determine the access that those individuals have. In one embodiment, the administrator may specify the levels to be displayed (e.g., three levels in FIG. 26) and may then list the subordinates for that position. The administrator may decide whether to grant access to the individual, the role for the individual, etc.

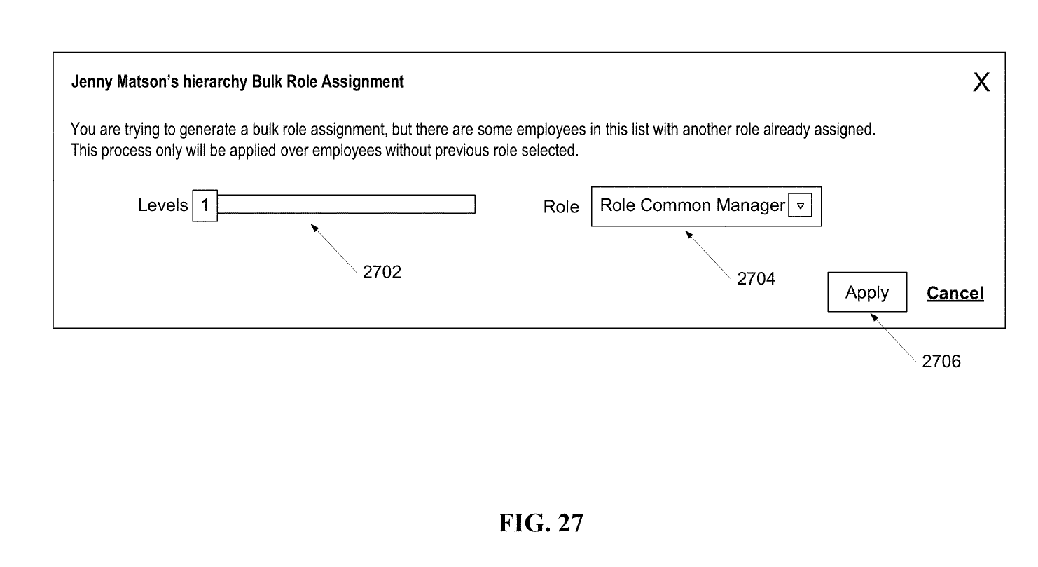

Referring to FIG. 27, an example of an interface for the bulk assignment of roles is provided. In the example, the administrator may use sider 2702 to select a level of the hierarchy, and use drop down menu 2704 to select the role for those at that level. By selecting “apply” interface 2706, the changes will be applied to all of the administrator's hierarchy at the selected level.

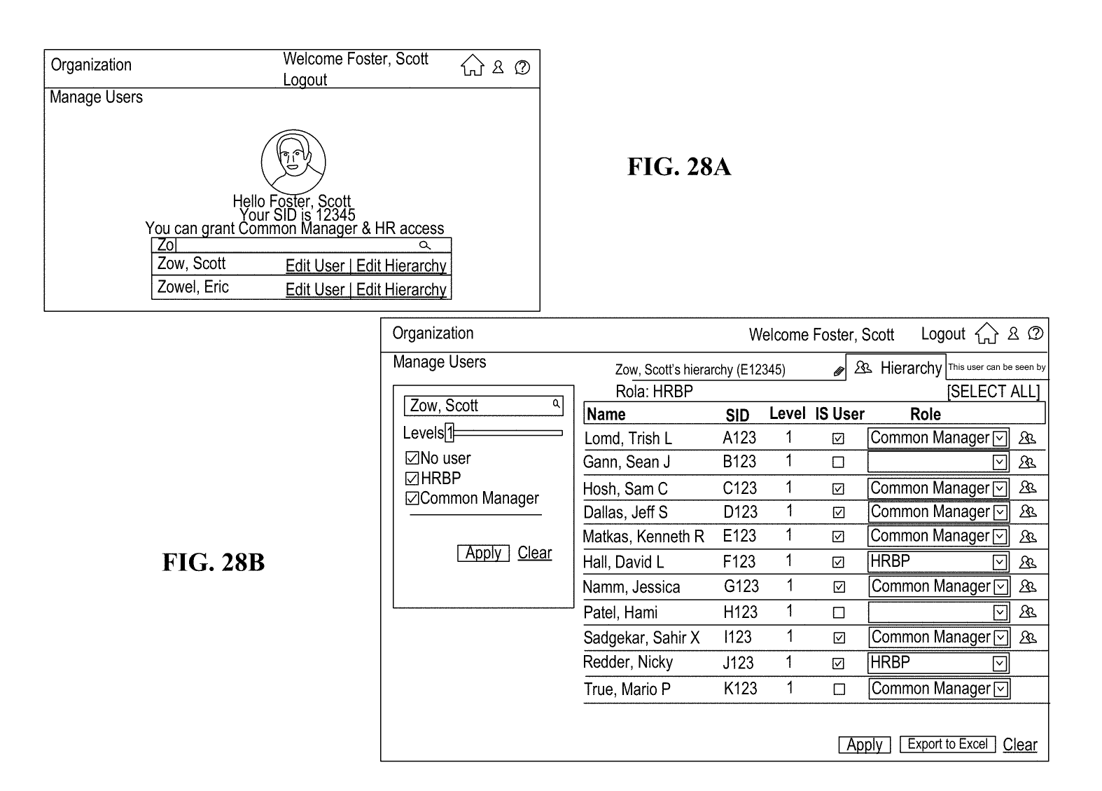

Referring to FIGS. 28A and 28B, example Manage Users screens are provided according to embodiments. In FIG. 28A, the administrator or manager, Scott Foster, can search for an individual using the search box, and the matching individual(s) are presented. In FIG. 28B, having selected “Scott Zow” from the search results in FIG. 28A, the administrator may then select the levels in Scott Zow's hierarchy and may then assign or change roles to those individuals.

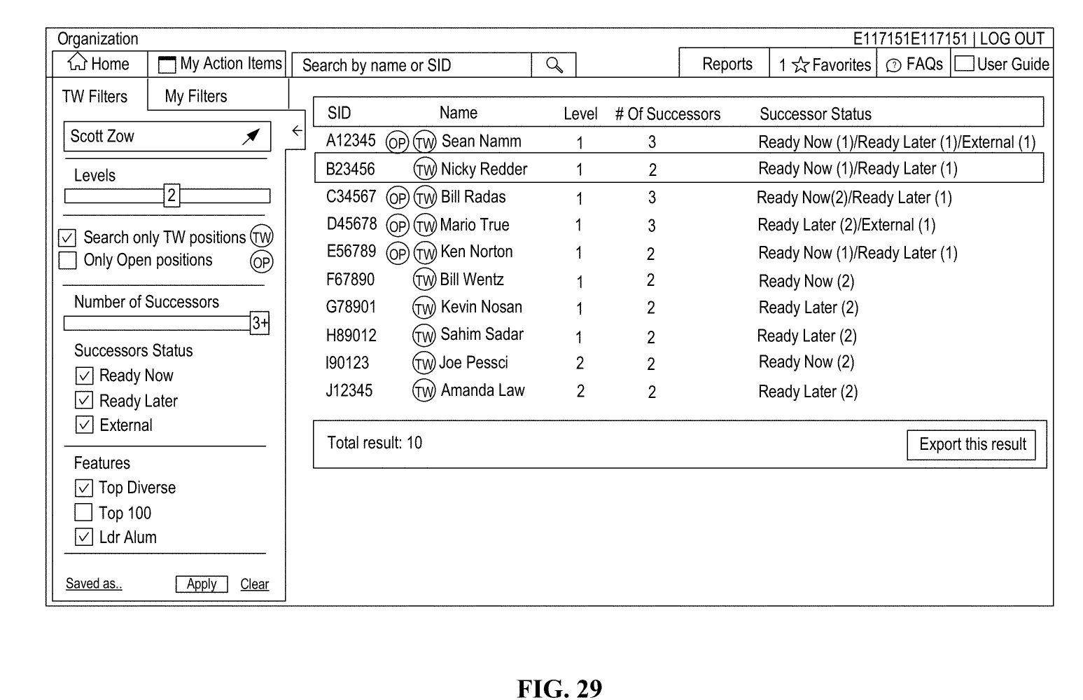

Referring to FIG. 29, an administrator or manager may view and search for Talent Wall data within their defined hierarchies. For example, the administrator or manager may select for positions that are subject to the talent wall, search for open positions, search for a particular successor status, and different features. The results may be reviewed, and profiles may be retrieved.

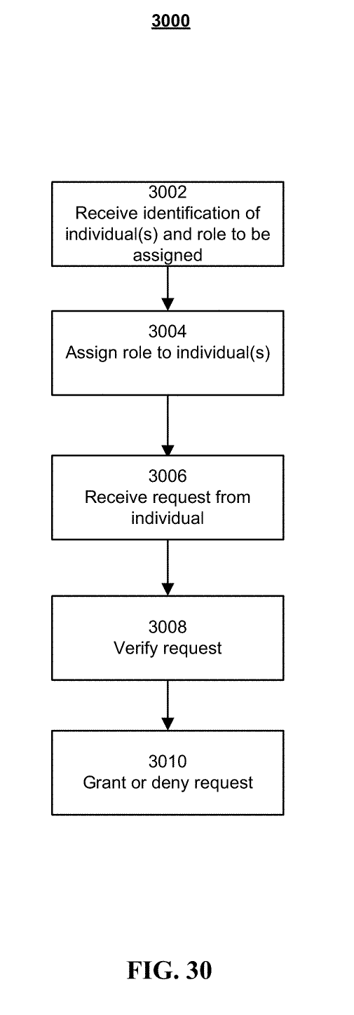

Referring to FIG. 30, a method for controlling access to and editing of an organizational directory is disclosed according to one embodiment.

In step 3002, an identification of one or more individuals that are going to be assigned roles and/or permissions is received. In one embodiment, a manager, a human resources employee, etc. may receive the identification of the employee or person what is associated with the organization.

In one embodiment, the identification may further include a role to which the individual(s) will be assigned. In one embodiment, this may include a level associated with the role. For example, an individual may be assigned the role of “Manager—Level 2.” Other roles and ways of identifying roles, levels, etc. may be used as necessary and desired.

In one embodiment, the role may be associated with one or more permission, entitlement, privilege, restriction, etc. In one embodiment, the roles may be hierarchical, in that each successive level of role may include the permissions, entitlements, privileges, restrictions, etc. may include the permission, entitlement, privilege, restriction, etc. of the lower-level roles.

In another embodiment, the permissions, entitlements, privileges, restrictions, etc. may be unique to each role.

In step 3004, the individual(s) may be assigned the role. Any suitable method may be used to assign the role, including placing the individual(s) in a group, adding an identifier to the profiles, etc.

In one embodiment, after the role is assigned, the individual(s) will be assigned the permissions, entitlements, privileges, restrictions, etc. associated with that role.

In step 3006, a request may be received from one of the individuals in an organization. In one embodiment, the request may be to access/edit a profile of a member of the organization (e.g., a subordinate employee), to access/edit a profile of an individual that is not a member of the organization (e.g., a potential hire), to access/edit a successor for an individual (e.g., add, move, delete, etc.), to search for a profile, etc. Any suitable operation may be requested as necessary and/or desired.

In step 3008, the request may be verified. In one embodiment, the request may be checked against the permissions associated with the role of the requesting individual.

In step 3010, if the request is verified, the request may be granted. If the request is not verified, the request may be denied.

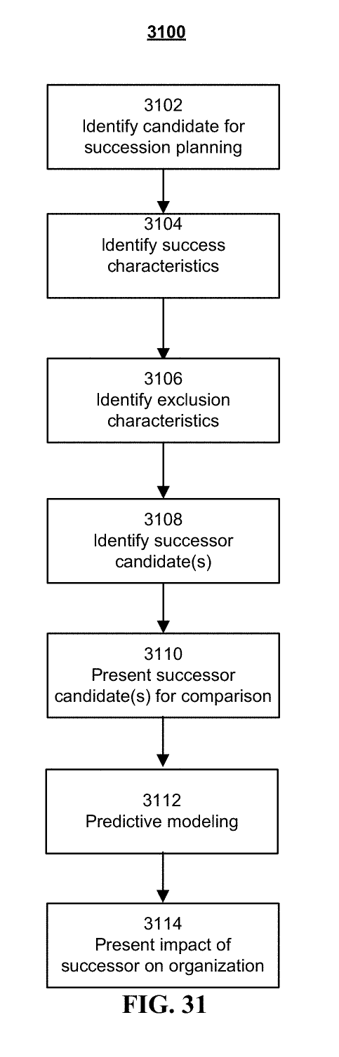

Referring to FIG. 31, a method for automatic identification of qualified successors is disclosed according to one embodiment is disclosed.

In step 3102, a candidate for succession planning is identified.

In step 3104, success characteristics for the candidate may be identified. For example, the candidate's education level, skill set, personality traits, training level, reviews (e.g., upward, downward, personal, etc.), personality description, etc. may be determined from the candidate's profile. In addition, success characteristics may be manually entered as necessary and/or desired.

In one embodiment, success characteristics from other similarly-situated individuals may be identified. For example, individuals that have the same job as the candidate may be considered as necessary and/or desired.

In step 3106, exclusion characteristics may be identified. These characteristics may be less than desirable characteristics about a candidate, and may be based from the candidate's “need improvement” items in reviews. Exclusion characteristics may be manually entered as necessary and/or desired.

In one embodiment, a sort of “ideal successor” may be defined by considering the success characteristics and the exclusion characteristics.

In step 3108, the system may search to identify successor candidates that meet some or all of the success characteristics. In one embodiment, exclusion characteristics may also be considered. In one embodiment, a score for each successor candidate may be provided.

In step 3110, the successor candidates may be presented for comparison.

In step 3112, predictive modeling may be used to predict the likelihood of each successor candidate's success as the successor.

In step 3114, the impact of the selection of one or more of the successor candidates on the organization may be provided. This may include, for example, the need for a successor for the selected successor candidate, economic impact (e.g., cost of moving the successor), estimated productivity impact, etc.

In one embodiment, after succession planning is complete, other systems (e.g., HR system, IT systems, payroll, etc.) may be updated to reflect the organization changes instantaneously, at a certain date in the future, or as necessary and/or desired. For example, a person who is changing positions may have new business cards ordered, IT entitlements (e.g., software access, restrictions, permissions, etc.) updated, payroll updated, etc.

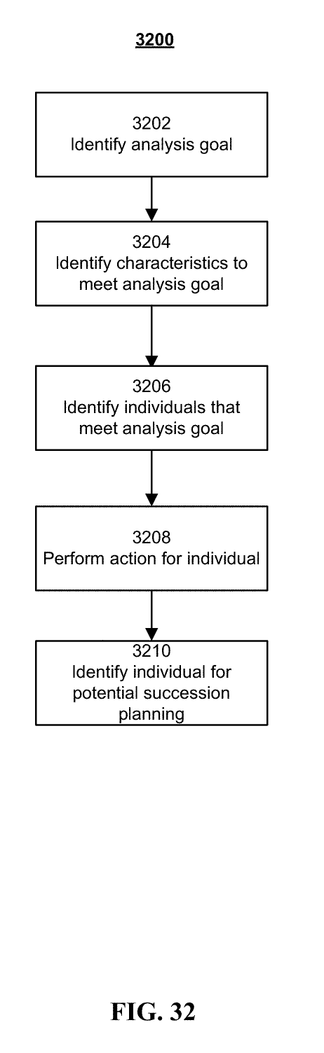

In one embodiment, a similar analysis may be performed to identify individuals that are likely to leave the organization, likely to be targeted by competitors, etc. Referring to FIG. 32, a analyzing individuals is disclosed according to one embodiment. In step 3202, an analysis goal for the organization may be specified. Example organization goals include, for example, high-value individuals likely to leave the organization, individuals likely to become targets for competitors, individuals likely to have a decrease in productivity, etc. Other organization goals may be specified as necessary and/or desired.

In step 3204, historical data may be analyzed to determine at least one characteristic that will be helpful in identifying persons that meet the analysis goal. For example, if the goal is to identify high-value individuals that are likely to leave the organization, an analysis engine may search profiles for individuals that have received good reviews, are productive, but may be underpaid, have not been promoted recently, have a history of job movement/career changes, etc. As another example, for individuals that are likely to be targets for competitors, the analysis engine may review historical records to identify characteristics of former employees that have been targeted by competitors. For example, this may include certain positions, salary ranges, fields, locations, etc.

In step 3206, the characteristics identified in step 3204 may be applied profiles of current individuals to identify those that meet the analysis goal.

In step 3208, actions to address the potential issue that is the subject of the analysis goal may be performed. For example, the names individuals that identified in step 3208 as likely to depart an organization may be submitted for additional review for promotion, salary increase, a non-monetary award (e.g., additional vacation day, office move, dinner with management, etc.). Any suitable action that may address the potential issue may be performed as necessary and/or desired.

In step 3210, the individual may be identified for succession planning as discussed above.

In one embodiment, predictive modeling may be used to identify individuals that may meet any other criteria as is necessary and/or desired.

Hereinafter, aspects of implementation of the various embodiments will be described. As described above, the method according to exemplary embodiments may be computer implemented as a system. The system of exemplary embodiments or portions of the system of exemplary embodiments may be in the form of a “processing machine,” for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

The description of exemplary embodiments describes servers, portable electronic devices, and other computing devices that may include one or more modules, some of which are explicitly depicted in the figures, others are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices (e.g., servers) instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, portable electronic devices, client devices, computers, etc.) separately. The functions described as being performed at various components may be performed at other components, and the various components may be combined and/or separated. Other modifications also may be made.

According to exemplary embodiments, the systems and methods may be computer implemented using one or more computers, incorporating computer processors. The computer implementation may include a combination of software and hardware. The computers may communicate over a computer based network. The computers may have software installed thereon configured to execute the methods of the exemplary embodiments. The software may be in the form of modules designed to cause a computer processor to execute specific tasks. The computers may be configured with hardware to execute specific tasks. As should be appreciated, a variety of computer based configurations are possible.

The processing machine described above may also utilize any of a wide variety of other technologies including a special purpose computer, a computer system including a microcomputer, mini-computer or mainframe for example, a programmed microprocessor, a micro-controller, a PICE (peripheral integrated circuit element), a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices for example capable of implementing the steps of the process according to exemplary embodiments.

It is appreciated that in order to practice the methods according to exemplary embodiments as described above, it is not necessary that the processors and/or the memories of the processing machine be physically located in the same geographical place. For example, each of the processors and the memories and the data stores used may be located in geographically distinct locations and connected so as to communicate in any suitable manner. Additionally, it is appreciated that each of the processor and/or the memory and/or data stores may be composed of different physical pieces of equipment. Accordingly, it is not necessary that the processor be one single piece of equipment in one location and that the memory be another single piece of equipment in another location. For example, it is contemplated that the processor may be two or more pieces of equipment in two or more different physical locations. These two or more distinct pieces of equipment may be connected in any suitable manner. Additionally, the memory may include two or more portions of memory in two or more physical locations. Additionally, the data storage may include two or more components or two or more portions of memory in two or more physical locations.

To explain further, processing as described above is performed by various components and various memories. However, it is appreciated that the processing performed by two distinct components as described above may, in accordance with a further embodiment, be performed by a single component. Further, the processing performed by one distinct component as described above may be performed by two distinct components. In a similar manner, the memory storage performed by two distinct memory portions as described above may, in accordance with a further embodiment, be performed by a single memory portion. Further, the memory storage performed by one distinct memory portion as described above may be performed by two memory portions. It is also appreciated that the data storage performed by two distinct components as described above may, in accordance with a further embodiment, be performed by a single component. Further, the data storage performed by one distinct component as described above may be performed by two distinct components.

Further, various technologies may be used to provide communication between the various processors and/or memories, as well as to allow the processors and/or the memories of exemplary embodiments to communicate with any other entity; e.g., so as to obtain further instructions or to access and use remote memory stores, for example. Such technologies used to provide such communication might include a network, such as a computer network, for example, the Internet, Intranet, Extranet, LAN, or any client server system that provides communication of any capacity or bandwidth, for example. Such communications technologies may use any suitable protocol such as TCP/IP, UDP, or OSI, for example. It should be appreciated that examples of computer networks used in the preceding description of exemplary embodiments, such as the Internet, are meant to be non-limiting and exemplary in nature.

As described above, a set of instructions is used in the processing according to exemplary embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming or any other suitable programming form. The software tells the processing machine what to do with the data being processed.

Further, it is appreciated that the instructions or set of instructions used in the implementation and operation of exemplary embodiments may be in a suitable form such that the processing machine may read the instructions. For example, the instructions that form a program may be in the form of a suitable programming language, which is converted to machine language or object code to allow the processor or processors to read the instructions. For example, written lines of programming code or source code, in a particular programming language, are converted to machine language using a compiler, assembler or interpreter. The machine language is binary coded machine instructions that are specific to a particular type of processing machine, e.g., to a particular type of computer, for example. The computer understands the machine language.

Any suitable programming language may be used in accordance with the various embodiments. Illustratively, the programming language used may include assembly language, Ada, APL, Basic, C, C++, C#, COBOL, dBase, Forth, Fortran, Java, Modula-2, Pascal, Prolog, RUM Ruby, Visual Basic, and/or JavaScript, for example. Further, it is not necessary that a single type of instructions or single programming language be utilized in conjunction with the operation of the system and method of exemplary embodiments. Rather, any number of different programming languages may be utilized as is necessary or desirable.

Also, the instructions and/or data used in the practice of exemplary embodiments may utilize any compression or encryption technique or algorithm, as may be desired. An encryption module might be used to encrypt data. Further, files or other data may be decrypted using a suitable decryption module, for example.

As described above, exemplary embodiments may illustratively be embodied in the form of a processing machine, including a computer or computer system, for example, that includes at least one memory. It is to be appreciated that the set of instructions, e.g., the software for example, that enables the computer operating system to perform the operations described above may be contained on any of a wide variety of computer readable media, as desired. Further, the data for example processed by the set of instructions might also be contained on any of a wide variety of media or medium. For example, the particular medium, e.g., the memory in the processing machine, utilized to hold the set of instructions and/or the data used may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors.

Further, the memory or memories used in the processing machine that implements exemplary embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods according to exemplary embodiments, a variety of “user interfaces” may be utilized to allow a user to interface with the processing machine or machines that are used to implement exemplary embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method exemplary embodiments, it is not necessary that a human user actually interact with a user interface used by the processing machine. Rather, it is contemplated that the user interface might interact, e.g., convey and receive information, with another processing machine, rather than a human user. Accordingly, the other processing machine might be characterized as a user. Further, it is contemplated that a user interface utilized in the systems and methods of exemplary embodiments may interact partially with another processing machine or processing machines, while also interacting partially with a human user.

While the embodiments have been particularly shown and described within the framework of succession planning and human resource management, such as collaborative succession planning for a financial institutions, it will be appreciated that variations and modifications may be effected by a person of ordinary skill in the art without departing from the scope of the various embodiments. Furthermore, one of ordinary skill in the art will recognize that such processes and systems do not need to be restricted to the specific embodiments described herein. Other embodiments, combinations of the present embodiments, and uses and advantages of the various embodiments will be apparent to those skilled in the art from consideration of the specification and practice as disclosed herein. For example, exemplary embodiments may be effectively implemented for other organizations management of personnel may be required. For example, professional sports teams may require such detailed management and succession planning as described herein. For example, professional football teams may use such planning for different positions and to plan for draft and trade picks. Accordingly, the present embodiments may be adapted to perform such functions as needed to support such professional sports teams. The specification and examples should be considered exemplary.

1. A computer implemented method for controlling access to and editing of an organizational directory, comprising:
receiving an identification of an individual to whom to grant at least one permission and an identification of a role out of a plurality of roles for an organization for the individual, each role of the plurality of roles having associated therewith at least one permission;
at least one computer processor assigning the role to the individual;
receiving a request for information from the individual regarding a database entry;
the at least one computer processor verifying that the at least one permission authorizes access to the requested information; and
the at least one computer processor providing access to the requested information.

2. The method of claim 1, wherein the request is to at least one of access, edit, search for, and delete the database entry.

3. The computer implemented method of claim 1, wherein the database entry is an individual profile for a member of the organization.

4. The method of claim 1, wherein the database entry is an individual profile for a non-member of the organization.

5. The method of claim 1, wherein the database entry is an identification of a successor for a member of the organization.

6. The method of claim 1, wherein the at least one permission comprises a hierarchy of permissions.

7. The method of claim 6, wherein the hierarchy of permissions is based on a level of role.

8. A computer implemented method for organizational planning, comprising:
receiving an identification of a first individual in a first position;
at least one computer processor identifying a plurality of success characteristics for the first individual from a first profile for the first individual;
the at least one computer processor identifying, from at least one database comprising a plurality of profiles, at least one second individual having a second profile comprising a predetermined amount of the success characteristics; and
the at least one computer processor performing predictive modeling to determine a likelihood of success for the second individual in the first position.

9. The method of claim 8, further comprising:
receiving an identification of at least one exclusion characteristic;
wherein the at least one second individual does not match a predetermined amount of the exclusion characteristics.

10. The method of claim 8, wherein the step of performing predictive modeling to determine a likelihood of success for the second individual in the first position comprises:
the at least one computer processor applying the second profile to historical data to determine the likelihood of success for the second individual.

11. The method of claim 8, wherein the success characteristics are selected from the group comprising an education level, a skill, a personality trait, a training level, and a review.

12. A computer implemented method for organizational planning, comprising:
receiving an identification of an analysis goal;
at least one computer processor identifying at least one individual that meets the analysis goal;
the at least one computer processor identifying an action to take for the identified individual; and
the at least one computer processor taking the identified action for the identified individual.

13. The method of claim 12, further comprising:
the at least one computer processor identifying at least one successor for the identified individual.

14. The method of claim 13, wherein the analysis objective is to identify an individual that is likely to leave an organization.
